(19) United States
(12) Patent Application Publication
(10) Pub. No.: US 2025/0196841 A1
(43) Pub. Date: Jun. 19, 2025

(54) VEHICLE CONTROL DEVICE

(71) Applicant: HITACHI ASTEMO, LTD., Hitachinaka-shi, Ibaraki (JP)

(72) Inventors: Yuki OKUDA, Hitachinaka-shi, Ibaraki (JP); Takashi OKADA, Hitachinaka-shi, Ibaraki (JP); Junichi OSAKI, Hitachinaka-shi, Ibaraki (JP)

(73) Assignee: HITACHI ASTEMO, LTD., Hitachinaka-shi, Ibaraki (JP)

(21) Appl. No.: 18/846,981

(22) PCT Filed: Apr. 22, 2022
(86) PCT No.: PCT/JP2022/018567

§ 371 Date: Sep. 13, 2024

(51) Int. Cl. B60W 20/13; B60W 10/06; B60W 10/08; B60W 10/26; B60W 20/12; G01C 21/34

(52) U.S. Cl. CPC B60W 20/13; B60W 10/06; B60W 10/08; B60W 10/26; B60W 20/12; G01C 21/3469; B60W 2556/10; B60W 2556/40; B60W 2556/45; B60W 2710/06; B60W 2710/08; B60W 2710/244

(57) ABSTRACT

Provided is a vehicle control device 21 capable of automatically starting electric traveling with high quietness in a case where a hybrid vehicle approaches a base without a driver performing a switching operation or setting a destination with respect to a navigation device when the hybrid vehicle travels near the base. The vehicle control device 21 is mounted on a vehicle 100 which switches between a first traveling state in which the vehicle 100 is driven by transmitting a driving force of an electric motor 107 by power supply from a battery 105 to drive wheels 109 and a second traveling state in which the vehicle 100 is driven with at least operation of an engine 102. The vehicle control device 21 includes a determination value storage unit 27 which allocates and stores, for each of a plurality of predetermined points, a determination value obtained based on a battery consumption amount required for the vehicle 100 to travel in the first traveling state from a predetermined point to the bases 31, 31A, and 31B and a target battery remaining amount at the time of arrival at the bases 31, 31A, and 31B, and a traveling state determination unit 28 which starts traveling in the first traveling state in a case where a current battery charge amount of the vehicle 100 exceeds a determination value corresponding to a current point of the vehicle 100.

### TECHNICAL FIELD

The present invention relates to a control device mounted on a hybrid vehicle.

### BACKGROUND ART

A hybrid vehicle including a drive wheel for driving a vehicle, a drive motor for driving the drive wheel, a battery for storing electric power, a generator for charging the battery, and an engine capable of driving the generator, the drive wheel, or both the generator and the drive wheel is known.

There has been proposed a hybrid vehicle capable of switching between electric traveling in which the vehicle travels by driving the drive wheel by the drive motor using only electric power stored in the battery without operating the engine, and hybrid traveling in which the vehicle travels while driving at least the engine and directly driving the generator or the drive wheel by driving the engine.

By the way, the hybrid vehicle has an advantage that since the engine is not driven by electric traveling, quietness in which no engine noise is generated can be obtained. For example, when the vehicle returns house at midnight or leaves early in the morning, it is desirable to perform electric traveling without noise generation that might hinder rest of nearby residents.

However, in the conventional hybrid vehicle, it is necessary for the driver to perform switching operation to electric traveling. In addition, depending on the remaining amount of the battery, the electric traveling may be ended before the vehicle reaches a base such as a house, and the desired electric traveling is not necessarily performed.

PTL 1 describes an on-vehicle device that enables a hybrid vehicle to travel with low noise while suppressing deterioration of fuel efficiency when traveling in a residential area, a neighborhood of a house, or the like. In the technique described in PTL 1, while the vehicle is traveling in the electric traveling area, the navigation device determines whether the time zone to which the current time belongs is the time zone in which the vehicle is traveling with low noise, and further determines whether the road on which the vehicle is traveling is a road on which the vehicle should travel with low noise. In a case where both results of the determination are positive determination, the navigation device stops the engine of the vehicle and notifies the hybrid ECU that electric traveling, which is traveling using only the motor as a power source, is performed. As a result, the electric traveling is performed without the driver performing the switching operation.

### CITATION LIST

### Patent Literature

PTL 1: JP 2009-280139 A

### SUMMARY OF INVENTION

### Technical Problem

However, the technique disclosed in PTL 1 starts electric traveling based on whether the vehicle is traveling in a place where electric traveling is desirable or traveling in the time zone where electric traveling is desirable, and it is considered that there is room for consideration as to whether or not the vehicle can reach the base or the like in the electric traveling state.

In addition, a minimum power specifying means is further included, and a means that specifies a route having a minimum power amount required for traveling in a region where electric traveling is desirable and performs route guidance based on the minimum power route specified by the minimum power specifying means is further included. As a result, although consideration is given to reach the base or the like in the electric traveling state, the driver needs to set a destination in the navigation device or the like, and needs to travel according to the route guide.

Although the switching operation to the electric traveling may be unnecessary, an operation of setting a destination is required instead. That is, it is desirable to realize a means for reaching the base or the like in the electric traveling state without the driver performing a switching operation or setting of a destination.

An object of the present invention is to provide a vehicle control device capable of automatically starting electric traveling with high quietness in a case where a hybrid vehicle approaches a base such as a house without a driver performing a switching operation or setting a destination with respect to a navigation device when the hybrid vehicle travels near the base such as the house.

### Solution to Problem

In order to achieve the above object, the present invention is configured as follows.

A vehicle control device mounted on a vehicle capable of switching between a first traveling state in which the vehicle is driven by transmitting a driving force of an electric motor by power supply from a battery to drive wheels and a second traveling state in which the vehicle is driven with at least operation of an engine, the vehicle control device including: a determination value storage unit which allocates and stores, for each of a plurality of predetermined points, a determination value obtained based on a battery consumption amount required for the vehicle to travel in the first traveling state from a predetermined point to a base and a target battery remaining amount when the vehicle reaches at the base; and a traveling state determination unit which starts traveling in the first traveling state in a case where a current battery charge amount of the vehicle exceeds the determination value corresponding to a current point of the vehicle.

In a vehicle control method of a vehicle capable of switching between a first traveling state in which the vehicle is driven by transmitting a driving force of an electric motor by power supply from a battery to drive wheels and a second traveling state in which the vehicle is driven with at least operation of an engine, map information is acquired, a predetermined point of the map information is set as a base, a route from a peripheral point of the set base to the base, an energy consumption amount in a case where the vehicle travels on the route toward the base, and a battery charge amount plan which plans the battery charge amount based on the energy consumption amount such that the vehicle travels on the route from a predetermined point of the route in the first traveling state, and reaches the base with a predetermined charge amount of a battery of the vehicle are acquired, via a communication device from a calculation resource installed outside the vehicle, a determination value obtained based on a battery consumption amount required for the vehicle to travel from a predetermined point to a base in the first traveling state and a target battery remaining amount at the time when the vehicle reaches the base is allocated and stored for each of a plurality of predetermined points, whether or not the vehicle travels in the first traveling state is determined by associating the charge amount of the battery according to the battery charge amount plan with a point of the route in the map information, and traveling in the first traveling state is started in a case where a current battery charge amount of the vehicle exceeds the determination value corresponding to a current point of the vehicle.

### BRIEF DESCRIPTION OF DRAWINGS

FIG. 1 is a vehicle configuration diagram in which a vehicle control device according to a first embodiment is applied to a series hybrid vehicle.

FIG. 2 is a block diagram illustrating a main part of a vehicle control device according to the present invention.

FIG. 3A is a diagram illustrating a map image illustrating an example of map data.

FIG. 3B is a diagram illustrating an example of a connection configuration of a link.

FIG. 4 is a schematic diagram of node connection information.

FIG. 5 is a diagram illustrating an example of a battery SOC planned by a battery charge amount planning unit.

FIG. 6A is a map image in a case where a base exists at a close position on map data.

FIG. 6B is a diagram for describing an example in which the first traveling state execution determination value is deployed in the road direction of the route.

FIG. 7 is a diagram for describing an operation when a first traveling state execution determination value is exceeded.

FIG. 8 is a diagram for explaining an operating state of the engine in a third traveling state.

FIG. 9 is an example of a screen projected on a display device of an interface device.

FIG. 10 is a block diagram illustrating a configuration of an energy consumption amount calculation unit corresponding to a first energy consumption amount calculation method.

FIG. 11 is a diagram illustrating an example of scoring for estimating an average velocity.

FIG. 12 is a diagram illustrating an example of an estimation equation of power consumption of a vehicle with respect to an average velocity.

FIG. 13 is a block diagram illustrating a configuration of an energy consumption amount calculation unit 25 corresponding to a second energy consumption amount calculation method.

FIG. 14 is a calculation flowchart of velocity pattern generation in a velocity pattern generation unit and an energy consumption amount in an energy consumption amount estimation unit.

FIG. 15 is a diagram for explaining a process of generating a velocity pattern in a velocity pattern generation unit.

FIG. 16 is a diagram for explaining a process of estimating an energy consumption amount.

FIG. 17 is a block diagram illustrating a main part of a vehicle control device according to a second embodiment of the present invention.

FIG. 18 is a block diagram illustrating a main part of a vehicle control device according to a fourth embodiment of the present invention.

FIG. 19 is a diagram illustrating an example of travel track records accumulated in a travel track record accumulation unit.

FIG. 20 is a diagram for explaining an example of charge-target SOC correction.

### DESCRIPTION OF EMBODIMENTS

Hereinafter, an embodiment of a vehicle control device according to the present invention will be described with reference to the drawings. In the drawings, the same elements are denoted by the same reference numerals, and redundant description thereof will be omitted.

In the description of the present invention, as the traveling state of the vehicle, a state in which traveling is performed aiming for noise reduction and contamination reduction, such as electric traveling in which the vehicle travels by driving a drive wheel by a drive motor using only electric power stored in a battery without operating an engine, is referred to as a first traveling state.

A traveling state in which the engine is operated to drive the generator or the drive wheel is directly driven to cause the vehicle to travel with the operation of the engine is referred to as a second traveling state.

Then, a traveling state in which traveling is performed aiming for noise reduction by reducing an output of the engine by the engine only driving the generator even with the operation of the engine is referred to as a third traveling state.

### EMBODIMENTS

### First Embodiment

### <<Vehicle Configuration>>

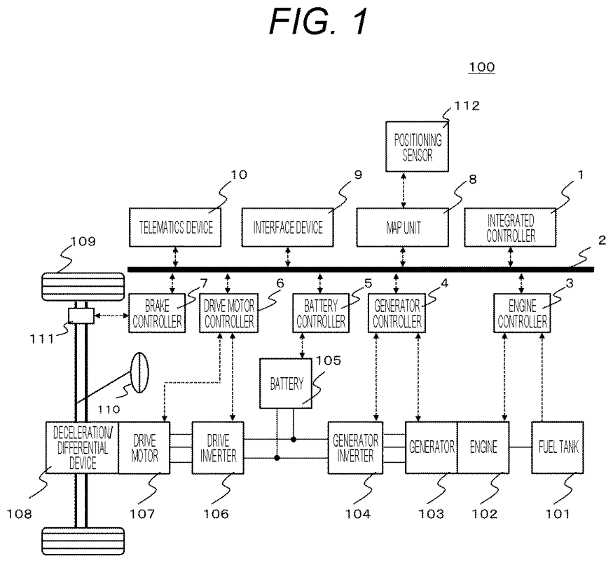

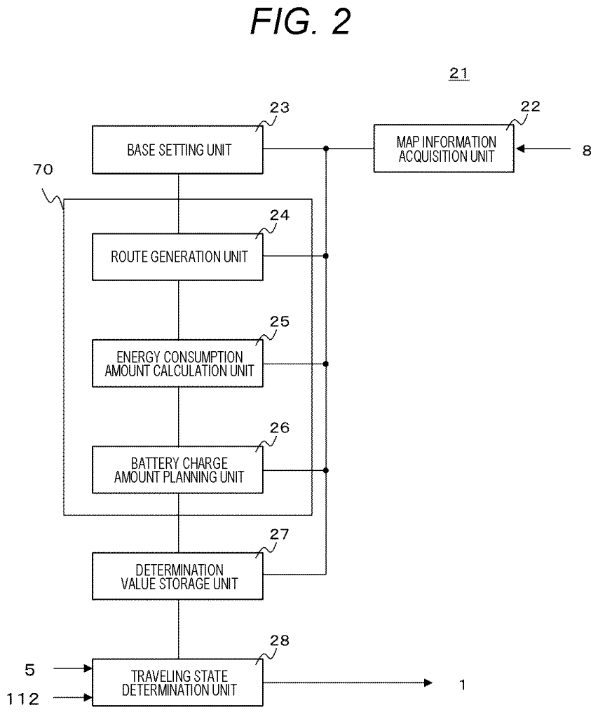

FIG. 1 illustrates a vehicle configuration diagram in which a vehicle control device 21 (illustrated in FIG. 2) according to the first embodiment is applied to a series hybrid vehicle 100.

A vehicle 100 illustrated in FIG. 1 burns fuel stored in a fuel tank 101 by an engine 102 to convert chemical energy of the fuel into heat and pressure energy by combustion, and converts it into rotational force (kinetic energy) via a piston mechanism or a crank mechanism (not illustrated) to drive a generator 103. In the generator 103, a magnet (not illustrated) rotates by the rotational force of the engine 102, and electric power is generated by electromagnetic induction. The electric power generated by the generator 103 is charged in a battery 105 via a generator inverter 104, and drives a drive motor (electric motor) 107 via a drive inverter 106.

In a case where the engine 102 is in a stopped state, the drive motor 107 is driven using only the electric power of the battery 105. In addition, in a case where the engine 102 is in the stopped state and the drive motor 107 requires further electric power or the charge amount of the battery 105 decreases, the generator inverter 104 is operated by the electric power of the battery 105, and the generator 103 is motor-driven to start the engine 102. Alternatively, the generator 103 may not be used to start the engine 102, and a motor for starting the engine 102 (not illustrated) may be further provided.

The driving force of the drive motor 107 rotates a drive wheel 109 via a deceleration/actuation mechanism 108 to move the vehicle 100 forward or backward.

In addition, the vehicle 100 can turn left and right by changing the angle of the drive wheel 109 by a steering device 110, and a brake actuator 111 converts kinetic energy into heat by pressing a friction material against a drum or a disc that rotates together with the drive wheel 109 to brake the vehicle 100. In addition, under a situation where the drive motor 107 is guided by the inertial force of the vehicle 100 via the deceleration/differential mechanism 108, the braking of the vehicle 100 can also be performed by regenerative driving of the drive motor 107 and the drive inverter 106. The electric power generated when the drive motor 107 is regeneratively driven is charged in the battery 104 via the drive inverter 106, and the kinetic energy of the vehicle 100 can be regenerated as electric power.

An integrated controller 1 including the vehicle control device 21 according to the first embodiment of the present invention transmits and receives various commands to and from an engine controller 3, a generator controller 4, a battery controller 5, a drive motor controller 6, and a brake controller 7 via a communication bus 2.

The integrated controller 1 determines target outputs of the engine 102 and the generator 103 so that the generator 103 can realize the power generation output to be achieved, and commands the target outputs to the engine controller 3 and the generator controller 4.

The engine controller 3 controls output torque of the engine 102 so that the engine 102 can realize the target output. A throttle opening degree of the engine 102, a fuel injection amount of the engine 102, and an ignition timing of the engine 102 are controlled base on a rotation speed and temperature of the engine 102 and an amount of air flowing into the engine 102.

The generator controller 4 adjusts a switching frequency and an output voltage of the generator inverter 104 based on a rotation speed and a temperature of the generator 103 so as to realize the target output of the generator 103 determined by the integrated controller 1.

The battery controller 5 measures a current and a voltage charged and discharged by the battery 105, detects a state of charge (hereinafter, referred to as a battery SOC or an SOC) of the battery, and transmits the state of charge to the integrated controller 1. Based on the SOC and the temperature of the battery 105, an output that can be charged and discharged by the battery 105 is determined and transmitted to the integrated controller 1.

The drive motor controller 6 controls a switching frequency and an output voltage of the drive inverter 106 based on a rotation speed and a temperature of the drive motor 107 so that the drive motor 107 can realize the driving force commanded by the integrated controller 1. The integrated controller 1 detects driving force requested by a driver from an operation amount of an accelerator pedal (not illustrated), and determines target torque of the drive motor 106.

The brake controller 7 controls a brake pressure generated by the brake actuator 111 so as to realize the braking force commanded by the integrated controller 1.

A map unit 8, an interface device 9, and the telematics device 10 are further linked to the integrated controller 1.

The map unit 8 provides map data corresponding to the current position of the vehicle 100 and the surrounding area obtained by a positioning sensor 112. It is possible to suitably use map data having a structure in which a shape and a connection state of a road are expressed by a connection between nodes (points) and links (nodes).

The node and the link can further include various kinds of attribution information such as various kinds of regulations, altitudes, gradients, cant, and curvatures in addition to coordinate information indicating the location of the node and the link, a width of a road, a direction in which the node and the link can travel, a mutual connection state, presence or absence of a signal, a speed limit, an average velocity and an average acceleration obtained by a traffic survey or the like, and travel time. Furthermore, dynamic information such as an actual velocity, an average velocity, and an average travel time obtained based on a roadside machine, probe information (floating car data), and the like may be updated by an arbitrary method via the telematics device 10.

The interface device 9 communicates with the integrated controller 1, the engine controller 3, the generator controller 4, the battery controller 5, and the drive motor controller 6, and displays information such as operation states of the engine 102, the generator 103, the battery 105, and the like, and the traveling velocity of the vehicle 100 through a user interface organized in a form easy for the driver to refer to. In addition, a navigation device that refers to the map information of the map unit 8, superimposes the position of the vehicle 100, and provides route guidance to a destination set by the driver may be formed.

The interface device 9 includes, in addition to notification means such as a meter, a display, a speaker, and a vibration element for providing information to the driver, input means such as a button, a volume, a lever, a microphone, a touch display, and a camera capable of accepting an instruction from the driver.

In addition, it may be formed to substitute the user interface using an external terminal such as a smartphone or a tablet terminal, to substitute or complement map data of the map unit 8, or to substitute or complement communication of the telematics device 10.

FIG. 1 illustrates a part not connected to the communication bus 2, but basically all elements may be connected to the communication bus 2 in some form. Although the present invention is not characterized, in the integrated controller 1, the presence of connection with an element (not illustrated) for executing processing required for operating the vehicle 100 is not limited thereto, and the integrated controller 1 and other controllers, units, and devices may execute processing other than the processing included in the disclosure of the present invention. The integrated controller 1 may include a plurality of controller groups, a part of the processing may be executed on a controller not mounted on the vehicle 100, and another controller (not illustrated) may be included in the configuration.

The various controllers, units, and devices including the integrated controller 1 include a microcomputer that performs calculation, a central processing unit (CPU), a non-volatile memory (Read Only Memory: ROM) that stores a program describing calculation processing, a main storage device (Radom Access Memory: RAM) that stores information in the middle of calculation, an analog-to-digital-converter (A/D converter) that quantizes an analog amount of a sensor signal and converts the analog amount into information usable by the program, a communication port for performing communication with other vehicle control devices 21, and the like.

In addition, a part or all of the above-described configurations, functions, processors, processing means, and the like may be realized by hardware, for example, by designing with an integrated circuit. In addition, each of the above-described configurations, functions, and the like may be realized by software by a processor interpreting and executing a program for realizing each function. Information such as a program, a table, a file, and the like for realizing each function can be stored in a storage device such as a memory, a hard disk, and a solid state drive (SSD), or a recording medium such as an IC card, an SD card, a DVD, and the like. In addition, the control lines and the information lines indicate those necessary for the description, and do not necessarily indicate all the control lines and the information lines on the product. In practice, it may be considered that almost all the configurations are connected to each other.

Although described briefly above, the vehicle 100 can realize motions such as running, turning, and stopping according to a request of a driver while providing information necessary for traveling to the driver with the above configuration.

### <<Configuration of Vehicle Control Device>>

FIG. 2 is a block diagram illustrating a main part of the vehicle control device 21 according to the present invention. The vehicle control device 21 may be formed to be included in the integrated controller 1 illustrated in FIG. 1, and may be formed to combine several controllers.

As illustrated in FIG. 2, the vehicle control device 21 of the first embodiment includes a map information acquisition unit 22 which acquires map data handled by the vehicle control device 21 from the map unit 8 or the like, a base setting unit 23 which associates a point as a main use base of the vehicle 100 such as a parking lot of a house or a business place with a point on the map data, a route generation unit 24 which generates a route for reaching the base from a periphery of the point as the base, an energy consumption amount calculation unit 25 which estimates an energy consumption amount generated when the vehicle 100 travels on the route generated by the route generation unit 24, and a battery charge amount planning unit 26 which plans an SOC of the battery 105 of the vehicle 100 based on the energy consumption amount obtained by the energy consumption amount calculation unit 25, a determination value storage unit 27 which allocates a determination value for the vehicle 100 to reach the base in a first traveling state (a traveling state aiming to reduce noise such as electric travel) in which the battery charge amount planned by the battery charge amount planning unit 26 and a point in the map data are associated to each of a plurality of predetermined points, and stores the value as determination information, and a traveling state determination unit 28 which compares the SOC of the battery 105 acquired from the battery controller 5 with the determination information stored in the determination value storage unit 27 based on the position of the vehicle 100 acquired from the positioning sensor 112, and determines whether the vehicle 100 travels in the first traveling state or the second traveling state.

The route generation unit 24, the energy consumption amount calculation unit 25, and the battery charging planning unit 26 form a calculation resource 70.

The determination value is determination information for determining whether the vehicle 100 travels in the first traveling state or not by associating the battery charge amount planned by the battery charge amount planning unit 26 with a point on the route in the map information.

The base setting unit 23 causes the interface device 9 to display the map information of the map unit 8, and the driver designates an arbitrary point on the map to set the base such as the house. In addition, it is also possible to set a point set as a destination where route guidance is expected as a base. The point set as the house corresponds to a destination or the like that can be set with a small number of operations by pressing the “Return to house button” when expecting route guidance. In addition, a point where a destination setting can be easily performed by registering in advance a place that is frequently visited even at a place other than the house, such as a hospital or facility where a family living apart from house, an acquaintance's house, or a workplace, in a navigation device (not illustrated) can also be considered as the base, and the base is set based on the registered point information. At this time, it does not matter whether route guidance is provided to a point registered in advance as a destination candidate in the navigation device.

The route generation unit 24 searches for and generates a plurality of routes from the periphery of the point set as the base by the base setting unit 23 toward the base, and generates connection information between links and nodes.

The energy consumption amount calculation unit 25 estimates an energy consumption amount generated when the vehicle 100 travels on the route set by the route generation unit 24.

The battery charge amount planning unit 26 plans the charging amount of the battery 105 required for the vehicle 100 to reach the base in the first traveling state when the vehicle 100 travels from the periphery of the base set by the base setting unit 23 to the base.

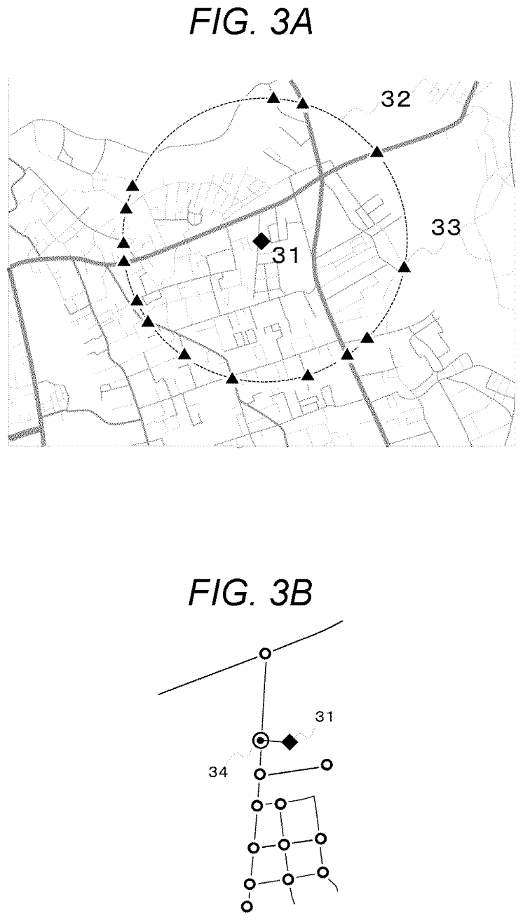

With reference to FIGS. 3A and 3B, a process of planning a battery charge amount in a case where a house 31 is set as a base will be described.

FIG. 3A is a map image illustrating an example of map data around the house 31 in which the house 31 is set as the base. When the house 31 is set by the base setting unit 23, a virtual circle 32 for separating a point within a predetermined distance range from the house 31 and the outside thereof is generated. The route generation unit 24 enumerates connections of nodes that can reach the house 31 with respect to nodes and links on the map included in the virtual circle 32, and generates connection information of nodes to be calculated by the energy consumption amount calculation unit 25.

Here, FIG. 3B illustrates an example of a connection configuration of a link by enlarging the vicinity of the house 31 in FIG. 3A, and a virtual base node 34 is generated on a link which is the nearest point of the house 31, nodes that can be connected with the base node 34 as a starting point are sequentially listed, and a search is performed up to a node at an end of a link intersecting the virtual circle 32 as an intersection 33 indicated by a filled triangle (▴) in FIG. 3A. Therefore, the node at the end of the link where the intersection 33 exists may exist outside the virtual circle 32.

The virtual circle 32 can be generated, for example, in a form of a radius of 1 km, 3 km, or 10 km from the point as the base, and can be set by a method of increasing the radius of the virtual circle 32 and performing iterative calculation while increasing the number of links to be calculated until the vehicle 100 cannot reach the house 31 only in the first traveling state even if at least one of the intersections 33 is set as the departure point based on the plan of the battery charge amount to be described later.

An enumeration algorithm such as a so-called breadth first search can be suitably used for searching and generating connection information of a node to be calculated by the energy consumption amount calculation unit 25. In the breadth first search, it is possible to enumerate in order from the node closer to the base node 34, and in a case where iterative calculation is performed to determine the virtual circle 32, it is possible to perform a search such as sequentially enumerating nodes that have been searched for and outer objects connected to links.

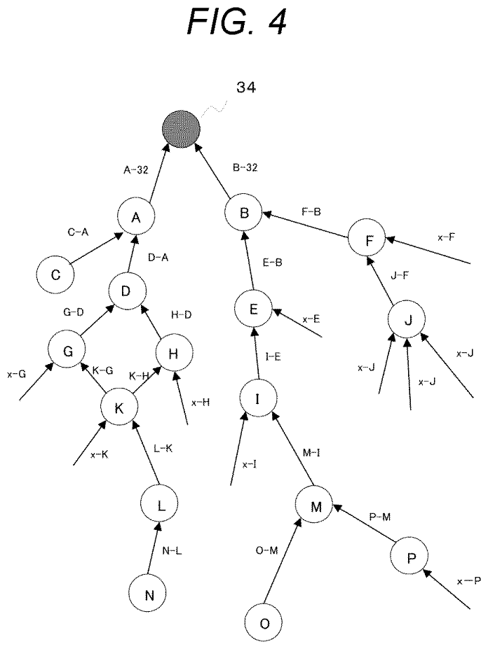

FIG. 4 schematically illustrates the connection information of the node obtained in this way, where a circle in FIG. 4 corresponds to a node on the map data, and a solid arrow which is the connection corresponds to a link on the map data. A node C, a node N, and a node O in which the link does not continue beyond the node are routes in which the exploration is finished as a link in which the intersection 33 is present or a dead end. A node (G, K, I, J, and P) to which only a link is partially connected still has a link in the virtual circle 32 ahead of the node, but this is not related to the description and is omitted. At this time, the route generation unit 24 generates connection information (hereinafter, referred to as return path node information) of a route node that can reach the base node 34.

The energy consumption amount calculation unit 25 calculates the energy consumption amount of the link corresponding to the return path node information generated by the route generation unit 24. Although a detailed calculation method of the energy consumption amount will be described later, the energy consumption amount calculation unit 25 calculates the energy consumption amount of the link unit constituting the connection information of the node, and associates the energy amount required for reaching the base node 34 with the node. For example, the energy amount required for reaching the base node 34 from the node I is the sum of the energy consumption amount of a link B-32, a link E-B, and a link I-E.

In this way, in the return path node information illustrated in FIG. 4, assuming that the base node 34 is set to the upstream side, the energy consumption amount when the vehicle 100 travels from an arbitrary node to the base node 34 can be obtained by summing the energy consumption amount from the upstream side to the downstream side. In addition, since the node connection information is generated in a form including the direction in which the link is connected to the node, that is, the traveling direction, it is possible to determine whether the vehicle is traveling toward the base by checking the order of passing through the node and the link.

Note that, for the node K, there are a route passing through the node G and a route passing through the node H as routes from the node K to the base node 34; however, a route having a shorter travel distance is adopted as consumption energy when traveling from the node K to the base node 34. In addition, it is also possible to adopt a route with lower consumption energy. That is, the energy consumption amount for each link such as a link A-32 and a link D-A is obtained and stored, and the total consumption energy amount from the base node 34 to the target node is stored for the node such as the node A and the node K, so that it is possible to see how much energy consumption occurs until reaching the base node 34 on a certain node.

The battery charge amount planning unit 26 plans the SOC of the battery 105 of the vehicle 100 that allows the vehicle 100 to reach the house 31 in the first traveling state based on the energy consumption amount calculation result of the energy consumption amount calculation unit 25 corresponding to the node connection information generated by the route generation unit 24.

First, an SOC to be secured by the battery 105 of the vehicle 100 when the vehicle reaches the house 31 is determined. In a case where the vehicle 100 departs from the house 31, it is not preferable that the battery 105 is fully used up, but is preferable that the battery is charged to some extent so that the vehicle 100 can travel in the first traveling state having high quietness. For example, it is preferable to select a charge amount corresponding to an intermediate amount between a charge amount at which battery 105 is fully charged (in terms of control) and a charge amount at which battery 105 needs to be charged, or an appropriate charge amount set for charging the battery 105 when vehicle 100 travels in the second traveling state.

Alternatively, in a case where the vehicle 100 reaches the house 31 in the first traveling state and leaves the house 31 in the first traveling state, the travel distances in the respective first traveling states may be distributed to be approximately the same. In addition, since the base node 34 is different from the place where the vehicle 100 is parked or stored, the SOC to be secured by the battery 105 of the vehicle 100 is determined in consideration of the energy consumption amount related to moving from the base node 34 to the place where the vehicle 100 is parked or stored and parking the vehicle 100. Here, for the sake of simplicity, a case where a charge amount corresponding to a middle between a charge amount at which the battery 105 is fully charged (in terms of control) and a charge amount at which the battery 105 needs to be charged will be described as an example.

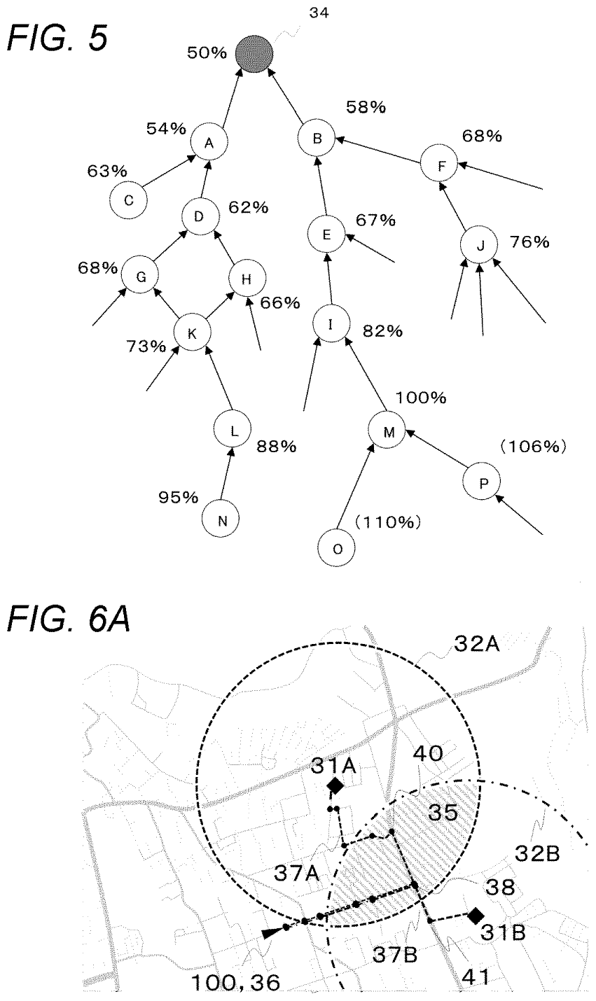

FIG. 5 is a diagram illustrating an example of the battery SOC planned by the battery charge amount planning unit 26 based on the return path node information illustrated in FIG. 4. In FIG. 5, the target SOC at the time of arrival at the base node 34 is set to 50%, and the SOC of the battery needs to be on the charge side in order to secure consumption energy every time the node advances to the downstream node, so that the downstream node has a higher value of the battery SOC.

When the battery charge amount SOCₙ at an arbitrary node n in the node connection information is obtained from the consumption energy amount, for example, the following equation (1) can be used.

$${SOC}_{n} = {SOC}_{0} + {U}_{n} / ( 3600 \cdot {V}_{bat} \cdot {C}_{bat} ) \qquad ( 1 )$$

In equation (1), the SOC₀ is a battery SOC corresponding to a charge amount to be secured by the battery 105 of the vehicle 100 in the base node 34, the Un is an energy consumption amount [J] at an arbitrary node n in the node connection information, the Vbat is a rated voltage [V] of the battery 105, and the C_{bat} is a rated capacity [Ah] of the battery 105. The 3600 in equation (1) represents 3600 seconds.

In FIG. 5, the battery SOC at the node P is 106%. The fact that the SOC of the battery 105 required for causing the vehicle 100 to reach the base node 34 in the first traveling state exceeds 100% means that recharging is required before the vehicle 100 reaches the base node 34 even if the vehicle is caused to travel in the first traveling state from the position of the node P, and in this case, it is not appropriate to cause the vehicle 100 to travel in the first traveling state at the point of the node P.

In addition, since it is not necessary to obtain the battery SOC for a node before (downstream of) the node P, the calculation may be ended here, and when the calculation is ended, an invalid value or 100% is set as a temporary value for the node for which the battery SOC is not set, so that it can be determined that switching to the first traveling state is not appropriate.

As described above, the SOC of the battery 105 required for the vehicle 100 to reach the base in the first traveling state with respect to the base set by the base setting unit 23 is set for the node corresponding to the end of the link within the virtual circle 32 and intersecting the virtual circle 32.

The determination value storage unit 27 stores and holds as a first traveling state execution determination value indicating the SOC of the battery 105 required for the vehicle 100 corresponding to the return path node information to reach the base such as the base 31, 31A or 31B in the first traveling state with respect to the base set by the base setting unit 23.

Based on the position of the vehicle 100 measured by the positioning sensor 112, the traveling state determination unit 28 acquires the first traveling state execution determination value of the connection destination node of the link on the map data corresponding to the road on which the vehicle 100 travels from the determination value storage unit 27, and compares the first traveling state execution determination value with the current SOC (for example, when the vehicle 100 is traveling on the road corresponding to a link J-F in FIG. 4, the value of the node F is referred to). In a case where the SOC of the battery 105 is on the charge side (the SOC of the battery 105 is larger) in comparison with the first traveling state execution determination value corresponding to the connection destination node, it is determined that the vehicle 100 travels in the first traveling state, and a request for traveling in first traveling state is output to the integrated controller 1.

In the first embodiment of the present invention, in FIG. 3A, the determination value storage unit 27 holds what state the SOC of the battery 105 of the vehicle 100 should be in in order to cause the vehicle 100 to travel in the first traveling state toward the house 31, which is the base, toward the house 31 with respect to the periphery (region inside the virtual circle 32) thereof. Therefore, even if the driver does not set the house 31 as a destination of navigation route guidance or the like, in a case where the driver is driving the vehicle 100 to travel toward the house 31, the vehicle 100 can be automatically switched to the first traveling state at an appropriate timing at which the SOC of the battery 105 can be secured so that the vehicle 100 can reach the house 31 while being traveling in the first traveling state toward the house 31, and the vehicle 100 can also travel in the first traveling state when departing from the house 31 in the next driving.

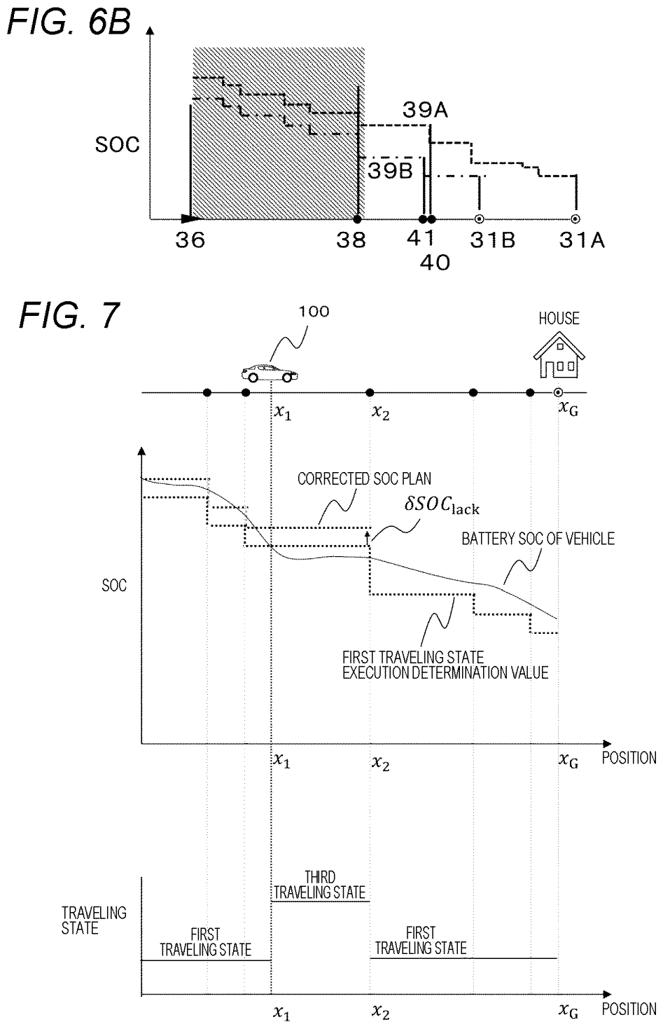

In the above description, an example in which one virtual circle 32 is generated with respect to the house 31 has been described, but it is also conceivable that the base exists at a position close to the house on the map data. As illustrated in FIG. 6A, in a case where there is a region 35 in which a region included in a virtual circle 32A for a certain base 31A and a region included in a virtual circle 32B for another base 31B overlap, the traveling state determination unit 28 determines switching of the first traveling state based on the determination value having a higher SOC.

In FIG. 6A, in a case where the vehicle 100 reaches a node 36 and the navigation device of the vehicle 100 does not execute the route guidance (destination setting is not performed), it is assumed that the vehicle 100 is heading to one of the base 31A and the base 31B from now. A route 37A is assumed as a route toward the base 31A, or a route 37B is assumed as a route toward the base 31B, and it is determined that destinations are different at a node 38.

At the time point of the node 36, it is not known which one of the base 31A and the base 31B the vehicle 100 is headed to, but since the vehicle enters the virtual circle 32A or the virtual circle 32B, switching to the first traveling state having high quietness is expected toward the base according to the vehicle control device 21 according to the first embodiment of the present invention.

In such a case, as described above, the traveling state determination unit 28 determines switching of the first traveling state based on the first traveling state execution determination value having a higher SOC.

FIG. 6B is a graph in which the first traveling state execution determination value is deployed in a road direction of a route from the node 36 to the base 31A or the base 31B.

In FIG. 6B, since the distance from the node 36 to the base 31A or the base 31B is different, when the battery SOC is planned so as to have the same SOC in the base 31A or the base 31B, for example, the value of the battery SOC to be the first traveling state execution determination value in the node 36 or the node 38 at the same point is different as in a plan 39A for the base 31A and a plan 39B for the base 31B.

In FIG. 6A, since a route 37A assuming that the vehicle travels to the first base 31A and a route 37B assuming that the vehicle travels to the second base 31B overlap from the node 36 to the node 38, the traveling state determination unit 28 determines a route in which the state of charge of the battery 105 needs to be high (the SOC of the battery 105 is larger) based on the first traveling state execution determination value based on the plan 39A, and determines switching of the vehicle 100 to the first traveling state.

Thereafter, depending on whether the vehicle 100 travels on the link toward the node 40 or the link toward the node 41 after passing through the node 38, in a case where the vehicle 100 travels toward the node 40, the first traveling state execution determination value based on the plan 39A is continuously used for the switching determination to the first traveling state. In the case of traveling to the node 41, the first traveling state execution determination value based on the plan 39B is changed to be used.

In this way, for example, in a case where the first traveling state execution determination value based on the plan 39B is referred to while the vehicle is traveling in the first traveling state while heading from the node 36 to the node 38, but the first traveling state execution determination based on the plan 39A is referred to after passing through the node 38, the battery 105 needs to be charged more. Therefore, it is difficult to continue the first traveling state, and there is a possibility that the vehicle 100 cannot reach the base 31A in the first traveling state with high quietness.

That is, the traveling state determination unit 28 refers to the first traveling state execution determination value on the charge side with respect to the region 35 caused by the overlapping of the virtual circle 32A or the virtual circle 32B with respect to the base 31A or the base 31B, and thus, it is possible to suppress the difficulty in continuing the first traveling state in the middle of traveling.

Hereinafter, an operation when the SOC of the battery 105 decreases and falls below the first traveling state execution determination value after the vehicle 100 automatically starts the control to continue the first traveling state while traveling inside the virtual circle 32 in FIG. 3 will be described with reference to FIG. 7.

In FIG. 7, it is assumed that, after the vehicle 100 automatically starts the first traveling state, the SOC becomes lower than the first traveling state execution determination value at a position x1, and the vehicle 100 cannot continue the first traveling state. The traveling state determination unit 28 commands the engine 102 of vehicle 100 to travel in the third traveling state aiming for noise reduction at the position x1.

In addition, the traveling state determination unit 28 commands the energy consumption amount calculation unit generation 25 and the battery charge amount planning unit 26 to calculate a charge amount change δSOC_{lack} corresponding to the insufficient energy consumption amount for the route from the position x1 to a position x2 at which the first traveling state execution determination value is updated, and updates the first traveling state execution determination value stored in the determination value storage unit 27 to a corrected SOC plan obtained by adding δSOC_{lack} to the upstream node from the position x2.

That is, using the fact that the vehicle 100 cannot continue the first traveling state as a trigger, the traveling state determination unit 28 stores the point where the first traveling state ends in the determination value storage unit 27, and corrects the execution determination value of the section where the execution determination value exists in the previous traveling route to the charge side.

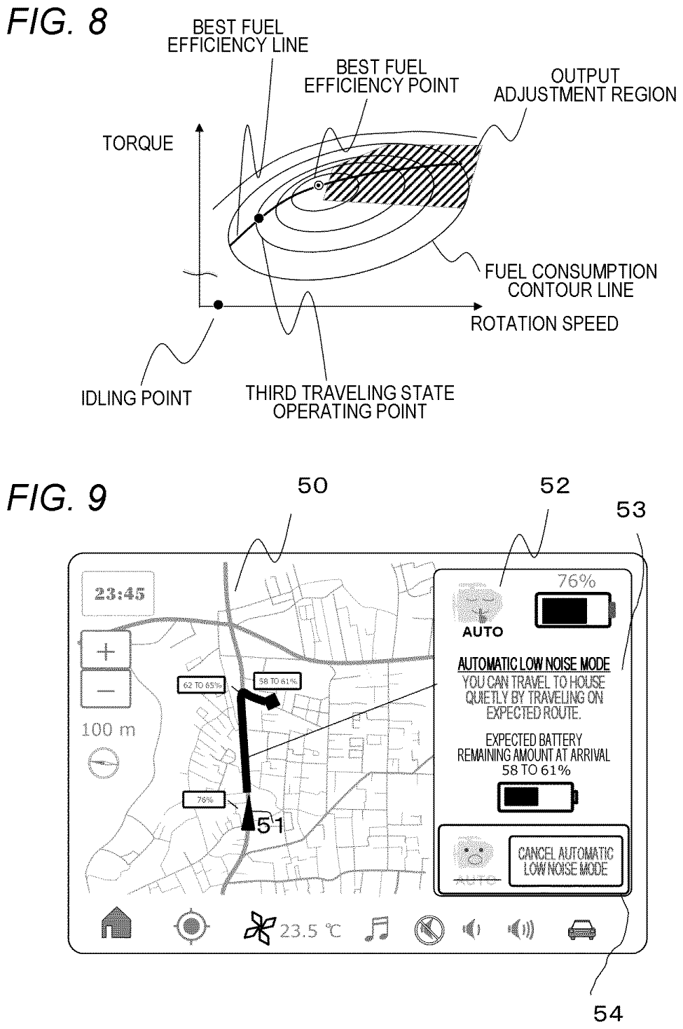

FIG. 8 is a diagram for explaining an operating state of the engine 102 in the third traveling state. In a case where the rotation speed of the engine 102 is taken on the horizontal axis and the torque achieved by mainly adjusting the throttle opening and the fuel injection amount of the engine 102 is taken on the vertical axis, it is known that the fuel consumption rate of the engine 102, that is, the fuel consumption, draws a contour line as shown as a fuel consumption contour line.

At this time, in a case where there is a best fuel efficiency point at which the efficiency of the engine 102 is maximized, and normally the battery 105 of the vehicle 100 is charged, the integrated controller 1 determines the outputs of the generator 103 and the engine 102 so that the engine 102 is operated at this operation point (best fuel efficiency point), and commands the generator controller 4 and the engine controller 3. In a case where the vehicle 100 requires a large driving force, in addition to the electric power from the battery 105, the electric power generated by the generator 103 is input to the drive inverter 106 and the drive motor 107, and in this case, the operating point of the engine 102 serving as the output adjustment region is mainly used.

In addition, there may be an operating point of the engine 102 at an idling point immediately after the start of the engine 102. Here, in the third traveling state, a third traveling state operating point which is on the best fuel efficiency line at which the efficiency is the highest at each engine rotation speed and is an operating point at which the output of the engine 102 is lower than the best fuel efficiency point or the output adjustment region is set, and the engine 102 and the generator 103 are driven at this operating point to charge the battery 105. The third traveling state operating point has a smaller rotation speed and a smaller torque than those of the best fuel efficiency point or the output adjustment region, and thus the output of the engine 102 decreases, but the noise can be reduced. Thus, the third traveling state operating point is suitable as an operating point of the third traveling state aiming for low noise.

As described above, when the SOC of the battery 105 decreases after the vehicle 100 automatically starts the control for continuing the first traveling state while traveling inside the virtual circle 32 in FIG. 3A and falls below the determination for continuing the first traveling state, as long as the vehicle 100 continues traveling toward the base, the driving state determination unit 28 commands the third traveling state so as to set the driving state to be aimed for as low noise as possible even when the engine 102 is in the driving state, to generate the corrected SOC plan, and to suppress the similar SOC shortage in the next and subsequent times.

Hereinafter, the operation of the interface device 9 according to the vehicle control device 21 of the present invention will be described.

FIG. 9 schematically illustrates an example of a screen projected on the display device of the interface device 9. Based on the map data registered in the map unit 8 and the measurement result of the positioning sensor 112, the interface device 9 superimposes the self-position of the vehicle 100 on the map image 50 and displays the superimposed self-position as an own vehicle icon 51. This screen allows the driver to check the driver's own position, the destination, and the positional relationship, as well as the surrounding facilities and the road shape at the driver's own position. A function for forming a so-called navigation device such as a button corresponding to changing a scale of a map image, an operation for returning a screen to a self-position, and the like, a function for displaying a different screen in order to control air conditioning, an audio device, and the like of the vehicle 100, a function for notifying a driver of a state of the engine 102 or the battery 105 of the vehicle 100, and the like are achieved by a known technology.

In a case where the first traveling state is automatically started, the vehicle control device 21 of the present invention notifies that the first traveling state (automatic low noise mode) is automatically started through the screen of the interface device 9 as described above by, for example, an icon 52 or a text 53.

With this configuration, the driver can confirm that the control for automatically continuing the first traveling state when the vehicle approaches the base is executed even if the destination or the like is not set in the navigation device.

Further, the interface device 9 can notify the driver of information for facilitating continuation of the first traveling state in addition to the notification that the first traveling state is automatically started. For example, a route to an assumed base, the SOC serving as the execution determination value of the first traveling state planned by the battery charge amount planning unit 26, and information regarding the base such as the battery SOC or the like in the base are notified based on the node connection information so as to be superimposed on the map image 50.

In a case where the driver does not desire the automatically started first traveling state, the first traveling state can be ended according to the intention of the driver by pressing a release button 54 or the like.

Here, an example in which the button is displayed on the interface device 9 has been described. However, in a case where the driver does not desire to automatically continue the first traveling state, the first traveling state can be ended by a method other than this. At this time, when the control for automatically switching to the first traveling is interrupted according to the intention of the driver, the traveling state determination unit 28 prohibits the control for automatically switching to the first traveling state until an operation for terminating the driving of the vehicle 100 after reaching the base or the like is executed, there is a request to resume the control by the driver, or the vehicle 100 exists outside the virtual circle 32 or the like.

In this way, it is possible to stop the function for the driver who does not desire to automatically switch to the first traveling state. In addition, after the vehicle 100 moves to the outside of the virtual circle 32 or the like, in a case where the vehicle 100 moves to the inside of the virtual circle 32 or the like with respect to the base again, the control for automatically switching to the first traveling state is started. In this way, even in a case where the driver forgets that switching to the first traveling state has been canceled by the intention of the driver, switching to the first traveling state can be attempted again, and it can be suppressed that the opportunity to provide the first traveling state having high quietness by switching to the first traveling state decreases.

In the description of the energy consumption amount calculation unit 25 described above, an example has been described in which one energy consumption amount for each link is obtained. However, for example, there is no problem in that an electric energy estimation unit 68B (illustrated in FIG. 13) described later calculates the energy consumption amount for each of a plurality of states such as a state where the power consumption is large and a state where the power consumption is low by changing the combination of the air conditioner, the lights, and the operation state, and the plurality of SOCs of the battery 105 is planned in the battery charge amount planning unit 26. In such a case, when referring to the determination value, the traveling state determination unit 28 can more accurately grasp the timing at which the SOC of the battery 105 is secured so that the vehicle 100 can travel in the first traveling state by referring to the determination value planned on the assumption of a configuration closer to the current configuration based on the use situation of the air conditioner and the lights of the vehicle 100.

Hereinafter, a calculation example of the energy consumption amount for each link will be described.

The first method is a method of obtaining the energy consumption amount based on the link length and average power consumption when the vehicle 100 travels in the first traveling state.

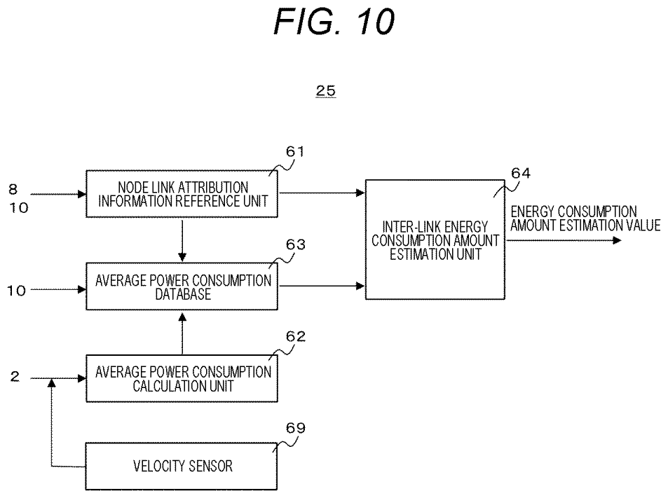

FIG. 10 is a block diagram illustrating a configuration of the energy consumption amount calculation unit 25 corresponding to the first energy consumption amount calculation method.

In FIG. 10, a node link attribution information reference unit 61 refers to the speed limit, the average velocity, and the link length corresponding to the link based on the map unit 8. An average power consumption calculation unit 62 calculates average power consumption for the traveling velocity of the vehicle 100 detected by a velocity sensor 69 from the distance that the vehicle 100 has traveled in the first traveling state and the battery SOC change amount. An average power consumption database 63 creates a database by associating the average power consumption with the traveling velocity of the vehicle 100 with the speed limit and the average velocity. An inter-link energy consumption amount estimation unit 64 estimates the energy consumption amount of the link to be calculated from the link length and the average power consumption of the vehicle 100.

The node link attribution information reference unit 61 may estimate insufficient attribution information in a case where sufficient attribution information cannot be obtained. For example, in a case where only the link length and the speed limit or the average velocity are obtained and the travel time for the link is not obtained, an estimated travel time T_{EST} is obtained from the link length and the speed limit of the link as in the following equation (2).

$${T}_{EST} = {L}_{LINK} / {V}_{REG} \qquad ( 2 )$$

In the equation (2), the L_{LINK} represents the link length [m] of a target link, and the V_{REG} represents the speed limit [m/s] of the link. An average velocity may be used as the V_{REG}.

In a case where the average velocity has not been obtained, a value obtained by multiplying the speed limit by a value such as 0.2 to 0.8 is substituted as the average velocity. The value such as 0.2 to 0.8 may be changed based on the number of lanes of a link, a road type, and the presence of a traffic light in a node to be connected.

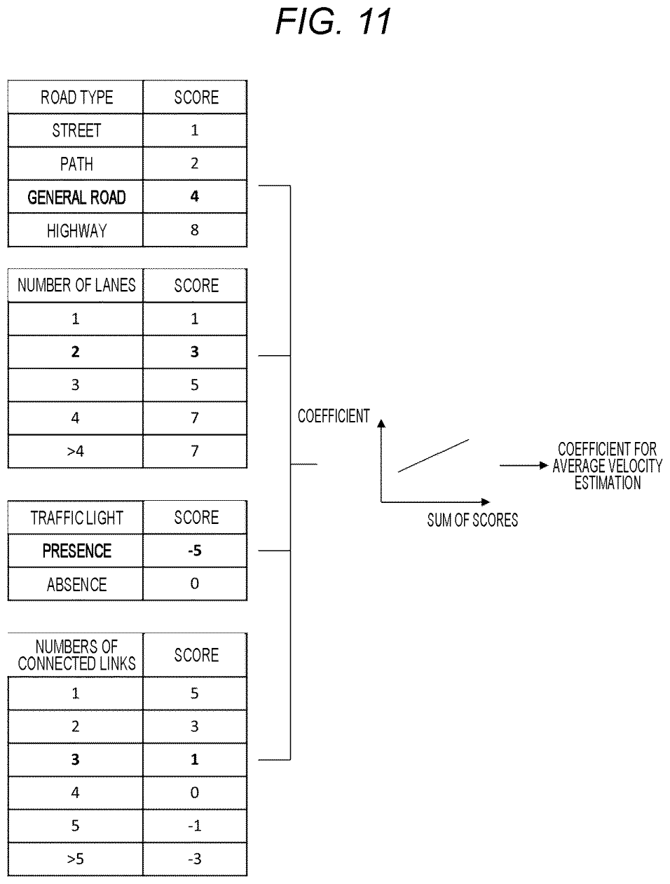

FIG. 11 is a diagram illustrating an example of scoring for estimating an average velocity, and a score value is set for each of the road types, the numbers of lanes, traffic lights, and the numbers of connected links. The link is scored based on the speed limit, the number of lanes, the presence or absence of a signal, and the number of links of the connection destination included in the target link, and the above coefficient is determined based on the score; however, the scoring may be performed by other factors.

The average power consumption calculation unit 62 takes the following equations (3), (4), and (5), converts a distance L_{EV} traveled by the vehicle 100 in the first traveling state and a battery SOC change amount δSOC for the travel into a power amount change δWₚ, obtains the power consumption p_{LINK} per unit traveling distance as follows, and calculates the energy consumption amount of the link by referring to the link length for each link using it.

$$δ SOC = {SOC}_{ST} - {SOC}_{EN} \qquad ( 3 )$$

$$δ {W}_{p} = δ SOC \cdot {C}_{B} \cdot {E}_{B} \qquad ( 4 )$$

$${p}_{LINK} = δ {W}_{p} / {L}_{EV} \qquad ( 5 )$$

The δSOC in the equation (3) is an SOC change amount before and after the vehicle 100 travels in the first traveling state, and is a difference between the SOC_{ST} at the time when the vehicle 100 enters the first traveling state and the SOC_{EN} at the time when the vehicle 100 ends the first traveling state. In the equation (4), the C_{B} represents the rated capacity of the battery 105, and the E_{B} represents the rated voltage of the battery 105. The electric energy change per unit travel distance in the first traveling state, that is, the power consumption p_{LINK} is calculated by the equation (5). Such the power consumption p_{LINK} is recorded for each opportunity when a set of SOC_{ST} and SOC_{EN} is obtained, and an average of the power consumption p_{LINK} for a plurality of times, for example, 10 times or 100 times is obtained by the equation (6), whereby the energy consumption rate P_{LINK} per unit travel distance can be obtained.

$${P}_{LINK} = ( {p}_{LINK ( 1 )} + {p}_{LINK ( 2 )} + ⋯ + {p}_{LINK ( n - 1 )} + {p}_{LINK ( n )} ) / n \qquad ( 6 )$$

In the equation (6), a number following a subscript as in p_{LINK (1)} is consumption energy per unit travel distance n times before, and the equation (6) is an example of calculation of an average of n times.

Using the P_{LINK}, the energy consumption amount U_{LINK} of the target link can be obtained by the following equation (7).

$${U}_{LINK} = {P}_{LINK} \cdot {L}_{LINK} \qquad ( 7 )$$

The L_{LINK} in the equation (7) is a link length of a link for which energy consumption amount is desired to be obtained.

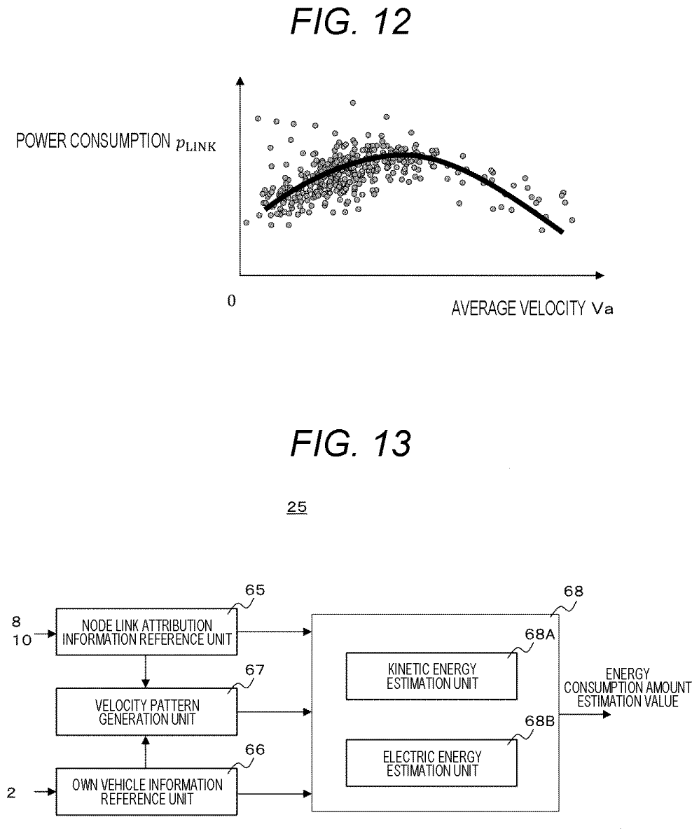

In these calculation processes, by calculating the average velocity in the first traveling state together and obtaining the estimation equation (6A) of the power consumption p_{LINK} of the vehicle with respect to the average velocity as illustrated in FIG. 12, the energy consumption amount corresponding to the traveling state in which the vehicle 100 has traveled in the past can be estimated by referring to the average velocity of the link to be calculated.

$${p}_{LINK} = a \cdot {( Va )}^{2} + b \cdot Va + c \qquad ( 6 A )$$

In the equation (6A), the Va is an average velocity, and the a, b, and c are constants.

In the second method, the energy consumption amount per unit time is calculated by estimating the balance of the storage forces generated in the vehicle 100.

FIG. 13 is a block diagram illustrating a configuration of the energy consumption amount calculation unit 25 corresponding to the second energy consumption amount calculation method.

In FIG. 13, a node link attribution information reference unit 65 and an own vehicle information reference unit 66 have substantially the same functions as the node link attribution information reference unit 61 and the own vehicle information reference unit 62 illustrated in the energy consumption amount calculation unit 25 of FIG. 10 corresponding to the first energy consumption amount calculation method. The node link attribution information reference unit 65 acquires attribution information of a link and a node corresponding to the return path node information based on the map unit 8 or the like. In this example, at least the length of the link, the speed limit of the link, the travel time of the link, the average velocity of vehicles traveling on the link, the average acceleration of vehicles traveling on the link, the gradient of the link, or the altitude of the node, and the presence or absence of a signal for the intersection corresponding to the node are acquired.

The own vehicle information reference unit 66 refers to design specifications and travel track record of the vehicle 100, and information of other controllers via the communication bus 2. As design specifications, a dry weight and an inertial weight of the vehicle 100, a riding capacity, a maximum loading amount, a front projection area, an air resistance coefficient, a rolling resistance coefficient of a tire, and the like are included. As the travel track record, the previously described average energy consumption rate, the average acceleration during acceleration or deceleration, and the like are included. The information to be referred to through the communication bus 2 includes a traveling velocity, or a remaining amount of fuel of the vehicle 100, a detection status of an occupant by a seating sensor, a wearing status of a seat belt, an SOC of the battery 105, a current and a voltage of the battery 105 measured by the battery controller 5, and an operation state of an air conditioner of the vehicle 100; however, the information to be referred to by the own vehicle information reference unit 63 is not limited thereto.

The vehicle weight may be estimated by a method of setting a value in which an occupant, fuel, and a load are added, or obtaining the vehicle weight from a change in acceleration expected by the driving force commanded by the integrated controller 1 and the acceleration actually generated in the vehicle 100, in addition to a value based on the design specifications of the vehicle 100 in order to approximate the actual vehicle weight of the vehicle 100. A value to be added to the value based on the design specifications may be an appropriate value selected from a riding capacity, a maximum loading amount, and the like of the vehicle 100 acquired by the own vehicle information reference unit 66. A value may be 100 kg or 130 kg assuming that two occupants are riding, a weight 0.5 times the maximum loading amount, a value obtained by detecting the number of occupants from a detection result of a seat belt wearing state of the occupant riding on the vehicle 100 or a seating sensor and multiplying a predetermined weight which is 50 kg or 65 kg per person, or a weight of the fuel estimated by multiplying a density by a remaining amount of the fuel. The inertial weight can also be set by referring to the design specifications. Of course, there is no problem even if the vehicle weight of the vehicle 100 is obtained by a known method of measuring or estimating the vehicle weight.

A velocity pattern generation unit 67 generates a temporary velocity change when the vehicle 100 travels on a link which is a calculation target of the energy consumption amount. For example, the velocity is planned at predetermined time intervals over the travel time of the link to be calculated, or the velocity is planned for each divided position by dividing at a predetermined distance with respect to the link length of the link to be calculated. Examples of such division include dividing the link at intervals of 50 m or 100 m, and dividing the link in the form of an acceleration region, a cruise region, and a deceleration region.

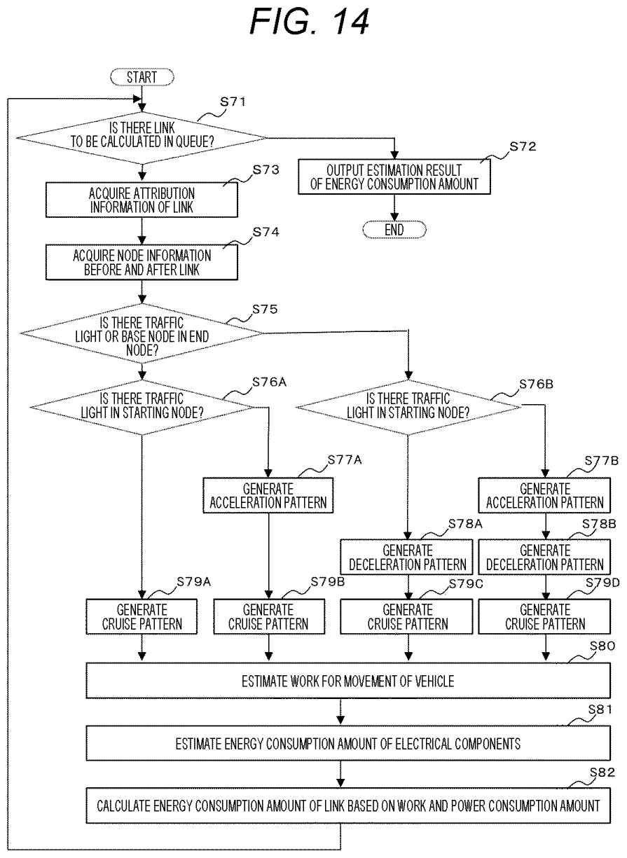

An energy consumption amount estimation unit 68 refers to various pieces of information from the planned velocity, the node link attribution information reference unit 65 and the own vehicle information reference unit 66, and estimates the energy consumption amount when the vehicle 100 travels on the target link. The energy consumption amount estimation unit 68 includes a kinetic energy estimation unit 68A and the electric energy estimation unit 68B. The assumption of the subsequent calculation will be described with reference to FIGS. 14, 15, and 16.

FIG. 14 is a calculation flowchart of the velocity pattern generation in the velocity pattern generation unit 67 and the energy consumption amount in the energy consumption amount estimation unit 68. First, the link to be calculated is held in a queue.

In FIG. 14, step S71 is a step of confirming whether there is a link to be calculated in the queue. Here, in a case where there is no link to be calculated, the calculation result of the energy consumption amount is output in step S72 and the processing is terminated, and otherwise, the subsequent processing is repeated until there is no link to be calculated in the queue.

In step S73, the attribution information of the link to be calculated is acquired from the node link attribution information reference unit 61 or the node link attribution information estimation unit 65.

In step S74, the attribution information of the nodes before and after the link to be calculated is acquired from the node link attribution information reference unit 61 or the node link attribution information estimation unit 65.

In step S75, it is determined whether the link is a link in which a traffic light or a base node exists in the node on the end point side based on the attribution information of the nodes before and after the link to be calculated. In a case where the link is not a link in which a traffic light or a base node exists in the node on the end point side, it is determined whether a traffic light exists in the starting node in step S76A or S76B. In steps S75 and S76A or S76B, a basic velocity pattern in the link to be calculated is selected based on whether or not a traffic light exists before and after the link to be calculated or whether or not the link to be calculated is connected to the base node.

Here, the basic velocity pattern is one of the following four types. That is, there are four types: cruise only (pattern A), acceleration and cruise (pattern B), cruise and deceleration (pattern C), and acceleration, cruise, and deceleration (pattern D).

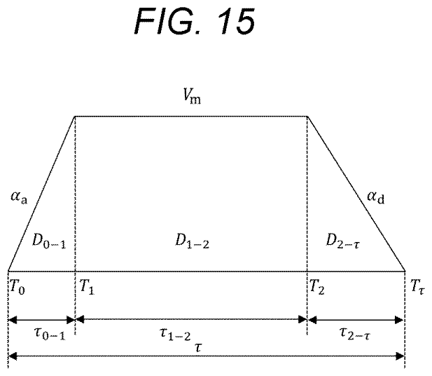

In the pattern A, the pattern B, the pattern C, and the pattern D, combinations of the acceleration pattern generation in step S77A or S77B, the deceleration pattern generation in step S78A or S78B, and the cruise pattern generation in steps S79A to S79D are different, but calculation procedures of the acceleration pattern generation, the deceleration pattern generation, and the cruise pattern generation are not changed. Therefore, here, a process of generating a velocity pattern in the velocity pattern generation unit 67 will be described with reference to FIG. 15 using a pattern D including all of the acceleration, cruise, and deceleration as an example.

The pattern D assumes a trapezoidal velocity pattern as illustrated in FIG. 15. That is, the vehicle accelerates to a velocity Vₘ in a period of τ₀₋₁ from time T₀ to time T₁ (corresponding to an acceleration pattern), travels at a velocity Vₘ over a period of τ₁₋₂ from time T₁ to time T₂ (corresponding to a cruise pattern), and then decelerates to a stop in a period of τ_{2-τ} from time T₂ to T_{τ} (corresponding to a deceleration pattern). At this time, the area of the trapezoid corresponds to the length of the link length. When the length of the link to be calculated is D_{LINK}, the average travel time is τ, the absolute value of the average acceleration during acceleration is aa, and the absolute value of the average acceleration during deceleration is α_{d}, the following equation (8) is obtained.

$${D}_{LINK} = 1 / 2 \cdot {τ}_{0 - 1} \cdot {V}_{m} + ( τ - ( {τ}_{0 - 1} + {τ}_{2 - 1} ) ) \cdot {V}_{m} + 1 / 2 \cdot {τ}_{2 - τ} \cdot {V}_{m} \qquad ( 8 )$$

The αₐ and α_{d} in the equation (8) are obtained by the following equations (9) and (10).

$${α}_{a} = {V}_{m} / {τ}_{0 - 1} \qquad ( 9 )$$

$${α}_{d} = {V}_{m} / {τ}_{2 - 1} \qquad ( 10 )$$

By eliminating τ₀₋₁ and τ_{2-τ} from the equation (8) based on the equation (9) and the equation (10), the following equation (11) is obtained.

$$( 1 / {α}_{a} + 1 / {α}_{d} ) \cdot {V}_{m}^{2} - 2 \cdot τ \cdot {V}_{m} + 2 \cdot {D}_{L I N K} = 0 \qquad ( 11 )$$

The measure Vm is expressed by the following equation (11A).

$$Vm = ( 2 \cdot τ \pm √ ( 4 \cdot {τ}^{2} - 8 \cdot ( 1 / {α}_{a} + 1 / {α}_{d} ) \cdot {D}_{L I N K} ) ) / ( 2 \cdot ( 1 / {α}_{a} + 1 / {α}_{d} ) ) \qquad ( 11 A )$$

The velocity Vₘ is obtained from the formulation of the solution of the quadratic equation in the equation (11). In the solution formula, two solutions are obtained, but here, a slower velocity Vₘ that is not a negative value is selected. The time-series velocity pattern V(t) can be generated by obtaining τ₀₋₁ and τ_{2-τ} from the obtained velocity Vₘ.

In step S77B, a velocity pattern during acceleration is generated from τ₀₋₁ and αₐ obtained as described above. The following equation (12) shows a velocity pattern V(t).

$$V ( t ) = {α}_{a} \cdot t \qquad ( 12 )$$

In the equation (12), the t represents an elapsed time from T₀ corresponding to the time from T₀ to T₁.

In step S78B, a velocity pattern during deceleration is generated from the velocity Vₘ, T_{2-τ}, and α_{d} by the following equation (13).

$$V ( t ) = {V}_{m} - {α}_{d} \cdot ( t - {T}_{2} ) \qquad ( 13 )$$

The (t−T₂) in the equation (13) corresponds to the elapsed time from T₂ corresponding to the time from the time T₂ to T_{τ}.

In step S79D, the velocity Vₘ obtained as described above is expressed by the following equation (14). A cruise pattern is generated.

$$V ( t ) = {V}_{m} \qquad ( 14 )$$

As shown in the equation (14), the cruise pattern assumes uniform motion.

Step S80 is calculation processing in the kinetic energy estimation unit 68A. The kinetic energy estimation unit 68A obtains work when the vehicle 100 is moved according to the velocity pattern from the balance of the holding forces generated in the vehicle 100, thereby estimating it as energy consumption related to the movement of the vehicle 100.

The total travel resistance Rₜ[N] obtained by synthesizing the air resistance, the rolling resistance of the road surface, the acceleration resistance, the resistance force generated by the gradient, and the like generated when the vehicle 100 moves is generally expressed by the following equation (15).

$${R}_{t} = μ \cdot M \cdot g + {K}_{air} \cdot {V}^{2} + M \cdot g \cdot sin θ + ( M + m ) \cdot α \qquad ( 15 )$$

In the equation (15), the μ is a rolling resistance coefficient of the traveling road surface, the M is a vehicle weight [kg], the g is a gravitational acceleration [m/s²], the Kₐᵢᵣ is an air resistance coefficient, the V is a traveling velocity[m/s], the θ is a road surface gradient, the m is an inertial weight [kg] at the time of acceleration, and the α is an acceleration[m/s²].

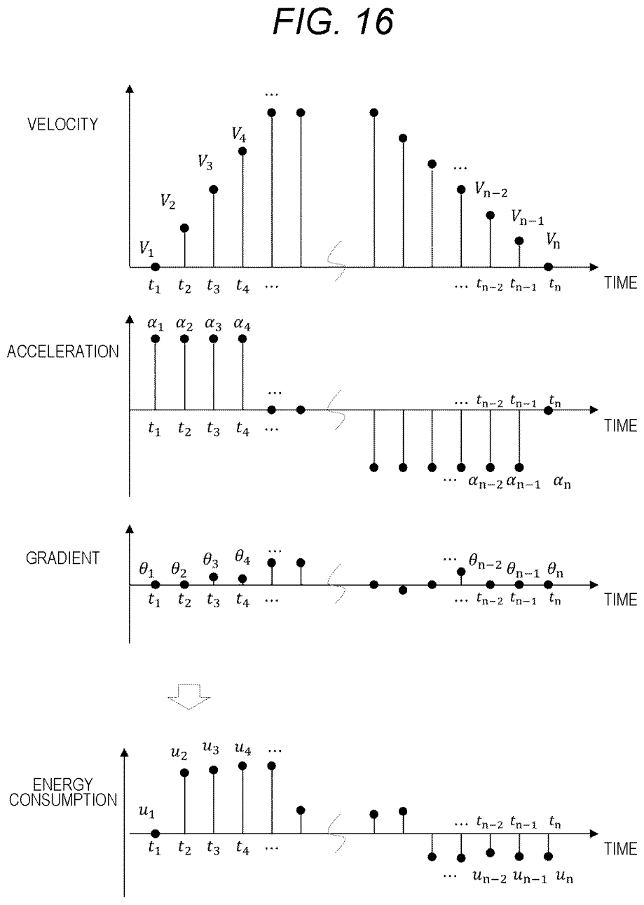

FIG. 16 is a diagram for describing a process of estimating an energy consumption amount for traveling of the vehicle 100 by the kinetic energy estimation unit 68A from the velocity pattern generated by the velocity pattern generation unit 67.

In FIG. 16, the velocity pattern is discretized at appropriate time intervals for simplification of calculation. For example, discretization such as taking values every 1 second or every 5 seconds can be performed over the travel time. The gradient θ_{[i]} is set from the velocity V_{[i]} and the acceleration α_{[i]} of the vehicle 100 and the position x_{[i]} on the link corresponding to the velocity pattern. An output p_{[i]} when the vehicle 100 is moved according to the velocity pattern is estimated and converted into the energy consumption u_{[i]} related to traveling (movement) of the vehicle 100 for processing in step S83 described later.

The energy consumption related to the traveling of the vehicle 100 is the product of the travel resistance, the moving distance, the reciprocal of the efficiency of the drive inverter 106 and the drive motor 107, and the reciprocal of the transmission efficiency of the deceleration/differential mechanism 108 when the vehicle 100 accelerates or cruise, and is obtained as the following equation (16).

On the other hand, when the total travel resistance Rₜ is negative, the vehicle 100 is in the regeneration state, and a limited value is set as the energy amount in which the vehicle 100 can be regenerated.

$${u}_{[ i + 1 ]} = {p}_{[ i ]} \cdot ( {t}_{[ i + 1 ]} - {t}_{[ i ]} ) \qquad ( 16 )$$

However, it is defined as the following equations (16A) and (16B).

$${p}_{[ i ]} = {R}_{t [ i ]} \cdot {V}_{[ i ]} \cdot 1 / ε \cdot 1 / η : when {R}_{t [ i ]} \geq 0 \qquad ( 16 A )$$

$${p}_{[ i ]} = max ( {R}_{t [ i ]} \cdot {V}_{{[ i ]}_{t}} , {P}_{r e g e n} ) : when {R}_{t [ i ]} < 0 \qquad ( 16 B )$$

Here, it is defined as the following equation (17).

$${R}_{t [ i ]} = μ \cdot M \cdot g + {K}_{air} \cdot {V}_{[ i ]}^{2} + M \cdot g \cdot sin {θ}_{[ i ]} + ( M + m ) \cdot {a}_{[ i ]} \qquad ( 17 )$$

In the equation (16A), the ε is the efficiency of the drive inverter 106 and the drive motor 107, and the η is the transmission efficiency of the deceleration/differential mechanism 108. In addition, in the equation (16B), the P_{regen} represents a charge input for regeneratively driving the drive motor 107 and the drive inverter 106 of the vehicle 100 to receive the battery 105, and the max(R_{t[i]}·V_{[i]}, P_{regen}) represents a large value of R_{t[i]}·V_{[i]} and P_{regen}.

Since the power p_{[i]} has a negative value during the regenerative driving, the battery 105 is limited to the charge input that can accept the regeneration amount when the regeneration amount is larger than p_{regen}. The subscript i is a number indicating the order of a link to be calculated when the link is divided over travel time.

Furthermore, the energy consumption amount Uₖ related to the motion of the vehicle 100 on the link to be calculated is obtained by the following equation (18) by taking the sum of the works u_{[i]}.

$${U}_{k} = Σ {u}_{[ i ]} \qquad ( 18 )$$

Step S81 is calculation processing in the electric energy estimation unit 66B. The energy consumption generated by various controllers including the integrated controller 1 of the vehicle 100, the map unit 8, the interface device 9, the telematics device 10, an air conditioner of the vehicle 100, lights such as a headlight, and a tail light, a wiper and a defroster are estimated.

Since these are electrical components and driven by electric power, not only an output (that is, consumption power and consumption energy per unit time) is obtained by measuring a voltage and a current, but also consumption energy per unit time can be obtained by referring to consumption power as design specifications, and this is set as a function of time.

Based on the travel time T_{LINK}[s] or T_{EST}[S] of the link obtained from the node link attribution information reference unit 61 or the node link attribution information reference unit 65, the electric energy estimation unit 68B obtains the energy consumption amount U_{E}[J] of the electrical components when traveling on the target link as in the following equation (19).

$${U}_{E} = {P}_{E} \cdot {T}_{LINK} \qquad ( 19 )$$

In the equation (19), the P_{E} is obtained by combining the consumption power of the electrical components of the vehicle 100, and corresponds to the sum of the consumption power [W] of various controllers and an air conditioner.

In step S82, the energy consumption amount estimation unit 68 adds up the calculation results of the kinetic energy estimation unit 68A and the electric energy estimation unit 68B and converts the result into the energy consumption amount of the link.

Although the example of the method of calculating the energy consumption amount for each link in the energy consumption amount calculation unit 25 has been described above, the first embodiment of the present invention is not limited thereto, and the energy consumption amount may be obtained by other means as long as the energy consumption amount of the vehicle 100 corresponding to the link of the return path node information can be estimated.

The accuracy of the energy consumption amount of the vehicle 100 is higher in the second method than in the first method, but the calculation amount increases. It may be the case where the calculation of the energy consumption amount of the link is first attempted by the second method, and in a case where the information necessary for the calculation of the energy consumption amount cannot be obtained, the energy consumption amount may be calculated by the first method, that is, some means may be combined.

According to the first embodiment of the present invention, it is possible to provide a vehicle control device capable of automatically starting electric traveling with high quietness in a case where a hybrid vehicle approaches a base such as a house without a driver performing a switching operation or setting a destination with respect to a navigation device when the hybrid vehicle travels near the base such as the house.

The first embodiment of the present invention has been described above. Hereinafter, modifications will be described.

### Second Embodiment

Next, a second embodiment of the present invention will be described.

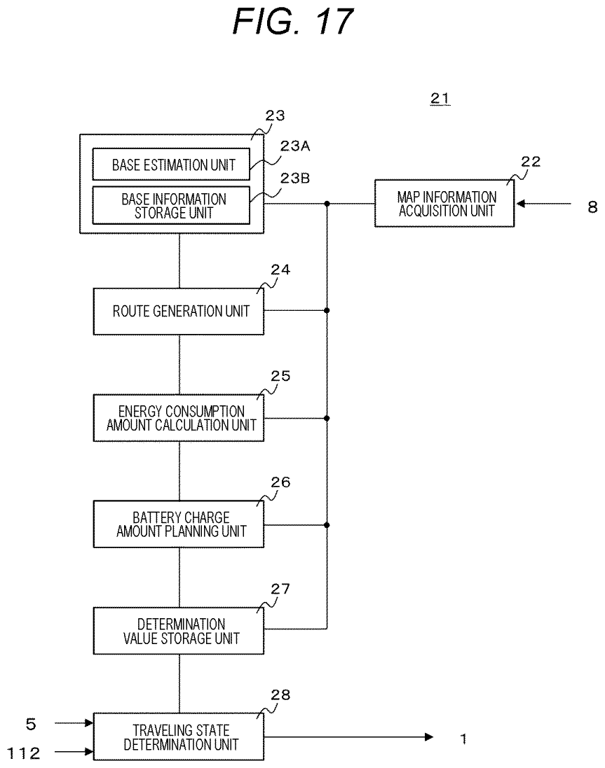

In the second embodiment of the present invention, the base setting unit 23 in the main part of the vehicle control device 21 illustrated in FIG. 2 in the first embodiment described above, includes a base estimation unit 23A and a base information storage unit 23B, and has a configuration illustrated in FIG. 17. Since other configurations are similar to those of the first embodiment, the base estimation unit 23A and the base information storage unit 23B included in the base setting unit 23 will be described.

The base estimation unit 23A causes the base information storage unit 23B to store information for estimating a base so as to refer to a point where the vehicle 100 has ended driving back to the predetermined number of times of driving, and estimates a point having a high appearance frequency of the point where the vehicle 100 has ended driving as a base. Then, it is determined whether or not to store information in the base information storage unit 23B based on the elapsed time from the end of driving of the vehicle 100 to the start of driving.

### <<Estimation of Base by Base Estimation Unit 23A and Base Information Storage Unit 23B>>

Similarly to the base setting unit 23 in the first embodiment of the present invention, the base estimating unit 23A estimates a point or a registration point set as a house by a driver as a base, further estimates a place where the vehicle 100 frequently visits as a base, and stores an estimation result as information for estimating the base in the base information storage unit 23B.

An estimation example of the base will be described below.

### <<Estimation Based on Driver Registration Point>>

A point where the driver sets a point on the map as a destination to which the navigation device is expected to provide route guidance is estimated as a base via the interface device 9. The point set as the house corresponds to a destination or the like that is set so that destination setting can be performed with a small number of operations by pressing a “return to house button” when the driver expects route guidance by the navigation device. In addition, a place set so that the destination setting can be easily performed by registering a frequently visited place or the like in advance in the navigation device such as a hometown, a house, a hospital, or a facility where a family living apart is living, an acquaintance's house, or a workplace other than the house can be a base to estimate.

### <<Estimation by Start Operation or Stop Operation>>

A point where a driver starts or ends driving of the vehicle 100 is estimated as a base. It is also conceivable that the destination other than the house, such as a hometown, a hospital, or a facility where a family living apart is living, an acquaintance's house, or a workplace described above is not necessarily registered in the navigation device by the driver.

Therefore, the base estimation unit 23A causes the base information storage unit 23B to store the position information and the time stamp as information for estimating candidates of the base when the start or end operation of driving of the vehicle 100 is performed.

The end of driving can be detected by operating an ignition key or a button to bring the vehicle 100 into a driving stop state or a standby state so as not to cause the vehicle 100 to immediately travel, or by selecting a parking range by a shift operation, as the driving end state.

Similarly to the end of driving, the start of driving can be determined by detecting an operation of an ignition key or a button to set the vehicle 100 to a driving state or a state where the vehicle 100 can travel by turning on the ignition, a selection of a range other than the parking range by a shift operation, or a release of the parking brake.

Based on the information for estimating the candidates of the base recorded in the base information storage unit 23B, the base estimation unit 23A estimates, as the candidates of the base, the top 3 or 5 points having a high appearance frequency among the driving end information such as the latest 10 or 100 times based on the information at the time of driving end.

The base information stored in the base information storage unit 23B may be subjected to appropriate grouping processing according to the mutual point distance. For example, a point within a radius of 10 m or 20 m from a certain point may be set as the same point, and the appearance frequency thereof may be enumerated. In this way, even if the measurement error is included in the positioning sensor 112, the base can be estimated in consideration of the error.

The base estimation unit 23A can perform processing of not holding the base information stored in the base information storage unit 23B as information to be stored in the base information storage unit 23B based on the facility information corresponding to the target position on the map data.

For example, in a case where the point to be stored in the base information storage unit 23B is a parking lot of a commercial facility or the like, it is easier to notify traffic participants such as other vehicles and pedestrians of the approach of the own vehicle if the travel with high quietness is not intentionally performed, and it is possible to avoid that the other vehicles collide with the own vehicle without noticing the own vehicle or the pedestrian is surprised without noticing the approach of the own vehicle.

The base estimation unit 23A can also estimate as a candidate of the base based on whether the end of driving or the start of driving is performed during a predetermined time based on the time stamp information among the base information stored in the base information storage unit 23B.

For example, it is based on the fact that one or both of the end of driving and the start of driving is performed on or after 22:00 or on or before 6:00, which is so-called midnight or early morning. The time of 22:00 or 6:00 is an example, and the driver may adjust these time zones, and the adjustment may be made in consideration of sunset, sunrise, or the like.

In addition, the base information storage unit 23B can also be configured not to hold information for estimating a candidate of the base to be recorded in the base information storage unit 23B for the information indicating that the idle time from the end of driving to the start of driving is made within a short period of time.

For example, in a case where the driving is resumed in a time period in which the idle time from the end of the driving to the start of the driving is 5 minutes or 15 minutes, it is considered that there is a high possibility that the point is for a purpose different from that of a point other than the above-described points other than the house where the user has stopped on the way of moving such as a rest area or a convenience store.

It may be determined whether or not to hold the information for estimating a candidate of the base to be recorded in the base information storage unit 23B based on the lapse of time from the end of driving to the start of driving as described above, or based on whether or not the end of driving or the start of driving is performed in so-called midnight or early morning based on the time stamp information itself.

Since resources for storing these information are not infinite, the base information storage unit 23B may be configured to store a predetermined stop of driving and start of driving by, for example, holding information about the stop of driving and the start of driving 100 or 1000 times in the past and discarding old information thereafter.

By setting the predetermined number of times, resources for storage necessary for holding these information can be saved. In addition, it is possible to store the end of driving and the start of driving separately, to store the stop of driving and the start of driving in combination, or to store either one of the stop of driving and the start of driving.

Since it is considered that the vehicle 100 hardly moves from the point where the driving is stopped, the point where the driving is ended and the point where the driving is started thereafter are usually the same point. However, when the point where the driving is ended and the point where the driving is started are different, the information may not be held in the base information storage unit 23B.

By increasing the number of cases of storing these information in the base information storage unit 23B, it is possible to increase the number of points to be candidates of the base, and it is possible to increase the opportunity to start the electric traveling with high quietness without the driver performing the switching operation or the setting of the destination.

On the other hand, by reducing the number of cases of storing these information in the base information storage unit 23B, resources required for holding the information can be reduced, and the invention can be implemented at low cost. However, the opportunity to start the electric traveling with high quietness without the driver performing the switching operation or the setting of the destination may be decreased, and it may be a trade-off.

Therefore, the number of cases of storing these information in the base information storage unit 23B is an adjustment matter of the company that implements the present invention, but it is preferable to store at least about 100 cases. For example, in a case where the vehicle 100 is used for commuting or the like, two points are stored for a case where the vehicle leaves house, reaches a workplace, and returns house from the workplace again.

Even in a case where the vehicle 100 is used for commuting for 5 days of the week, the vehicle 100 is used for the purpose of vacation or shopping to travel to a different point on the weekend, and 10 points are stored for 2 days, information for the past 5 weeks can be held, and information considered to be sufficient for estimating the base based on the behavior of the driver who operates the vehicle 100 can be secured.

The configuration after the base is estimated by the base estimation unit 23A is similar to that of the first embodiment of the present invention.

According to the second embodiment of the present invention, the same effects as those of the first embodiment are obtained. Since the base is estimated by the base estimation unit 23A, even if the driver does not register the point in the navigation device in the form of the house, the destination, or the registration point, it is possible to automatically switch the traveling state to the first traveling state having high quietness with respect to the place frequently visited by the vehicle 100.

### Third Embodiment

Next, a third embodiment of the present invention will be described.

In the third embodiment of the present invention, the route generation unit 24 in the main part of the vehicle control device 21 illustrated in FIG. 2 in the first embodiment further generates outward node information departing from the base, in addition to the return path node information from the periphery of the base to the base, and estimates the energy consumption amount by the energy consumption amount calculation unit 25 for the outward node information as well.

In the third embodiment, the route generation unit 24 generates routes from the bases 31, 31A, and 31B to the periphery of the bases 31, 31A, and 31B, and the battery charge amount planning unit 26 corrects the charge amount when the vehicle 100 reaches the bases 31, 31A, and 31B based on the difference between the energy consumption amount of the routes from the periphery of the bases 31, 31A, and 31B to the bases 31, 31A, and 31B and the energy consumption amount of the routes from the bases 31, 31A, and 31B to the periphery of the bases 31, 31A, and 31B.

Other configurations of the third embodiment are similar to those of the first embodiment, and thus illustration and detailed description thereof are omitted.

As the first embodiment of the present invention, an example in which the battery charge amount planning unit 26 sets the battery 105 to be 50% when reaching the house 31 is shown in FIGS. 3A and 3B. However, with a charging amount simply corresponding to the middle of the charging amount of the battery 105, there is a possibility that a deviation occurs in the distance in which the vehicle can travel in the first traveling state between the case of traveling to the house 31 and the case of departing from the house 31. The third embodiment of the present invention is an example in which the distance in both cases is set to be the same distance as much as possible.

Similarly to the first embodiment of the present invention, the route generation unit 24 generates a virtual base node 34 on a link that is the nearest point of the house 31, and sequentially enumerates nodes that can be connected with the base node as a starting point, thereby generating connection information (outward node information) of a node that is included in the virtual circle 32 from the base node 34 and can be reached from the base 31.

Similarly to the first embodiment of the present invention, the energy consumption amount calculation unit 25 also calculates the energy consumption amount in units of links. Also on the outward node, by summing up the energy consumption amount toward the downstream node with the base node 34 as the upstream, the energy consumption amount when the vehicle 100 travels from the base node 34 to any node can be obtained.

Similarly to the first embodiment of the present invention, the battery charge amount planning unit 26 plans the SOC of the battery 105 of the vehicle 100 that allows the vehicle 100 to reach the house 31 in the first traveling state based on the energy consumption amount calculation result of the energy consumption amount calculation unit 25, and determines the SOC (tSOC) of the battery 105 that needs to be secured by the vehicle 100 at the time of reaching the house 31 as in the following equation (20).

$$tSOC = nSOC + ( δ {SOC}_{o} - δ {SOC}_{r} ) / 2 \qquad ( 20 )$$

In the equation (20), the nSOC is a target SOC of the battery 105 when the vehicle 100 travels in the second traveling state, the δSOCo is an SOC change amount when the vehicle 100 travels in the first traveling state from the base node 34 to a node outside the virtual circle 32, and the δSOCr is an SOC change amount when the vehicle 100 travels in the first traveling state from the node outside the virtual circle 32 to the base node 34.

Note that, since the δSOCₒ and the δSOCᵣ normally include a plurality of nodes outside the virtual circle 32, the average values of the SOC change amounts of the corresponding nodes are the δSOCₒ and the δSOCᵣ, respectively.

The third embodiment of the present invention can obtain the same effect as that of the first embodiment. In addition, in the third embodiment of the present invention, attention is paid to the link intersecting with the virtual circle 32, and the charge amount of the battery 105 to be secured by the battery of the vehicle 100 at the time when the vehicle reaches the house 31 is corrected based on the difference between the energy consumption amount corresponding to the outward node information and the energy consumption amount corresponding to the return path node information, whereby the distance that the vehicle 100 can travel in the first traveling state can be made the same as much as possible between the case where the vehicle travels to the house 31 and the case where the vehicle departs from the house 31.

### Fourth Embodiment

Next, a fourth embodiment of the present invention will be described.

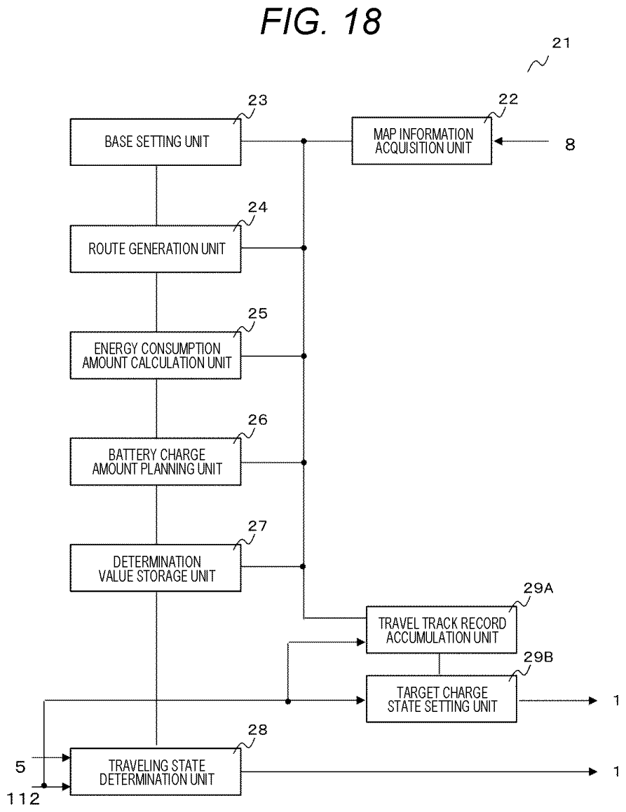

In the fourth embodiment of the present invention, the vehicle control device 21 illustrated in FIG. 2 in the first embodiment of the present invention further includes a travel track record accumulation unit 29A and a target charge state setting unit 29B, and is configured as illustrated in FIG. 18. The other configurations are the same as those of the first embodiment, and thus illustration and detailed description thereof are omitted.

In FIG. 18, the travel track record accumulation unit 29A accumulates the travel track records of the vehicle 100 in association with the map data acquired from the map unit 8.

In a case where the vehicle 100 travels in the second traveling state outside the virtual circle 32 in FIG. 3, the target charge state setting unit 29B corrects the target charge state of the battery 105 to be higher for a link in which the vehicle 100 travels with a higher frequency based on the travel track records accumulated in the travel track record accumulation unit 29A.

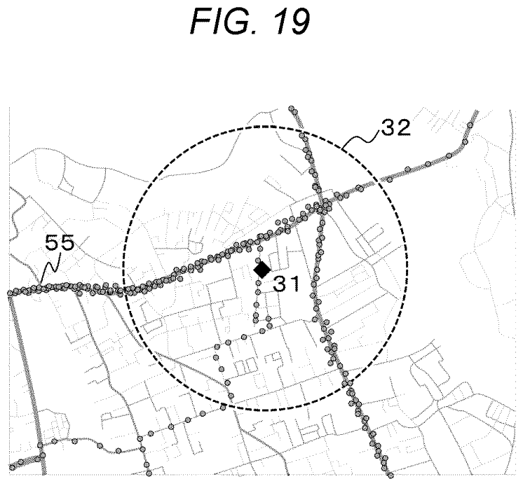

FIG. 19 is a diagram schematically illustrating travel track records accumulated in the travel track record accumulation unit 29A. The travel track record is accumulated by associating the position information obtained from the positioning sensor 112 with the map data of the map unit 8 or the like every time the vehicle 100 travels a predetermined distance or a predetermined time elapses in a driving state.

A point 55 in FIG. 19 corresponds to the travel track record. At this time, the charge target SOC when the vehicle 100 travels in the second traveling state is corrected for the link having the travel track record and intersecting the virtual circle 32.

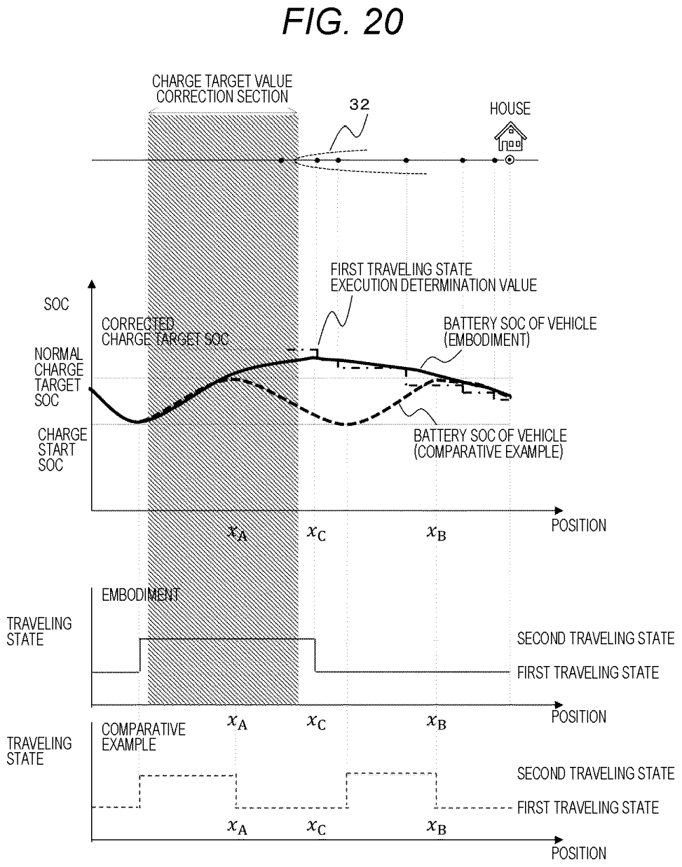

FIG. 20 is a diagram for explaining the SOC change in a case where such correction is made. The chart has a position on the horizontal axis, and a house as a base exists at the right end. According to any one of the first to third embodiments of the present invention, the first traveling state execution determination values for starting the first traveling state corresponding to the bases 31, 31A, and 31B and the bases 31, 31A, and 31B are planned from the house to the node outside the virtual circle 32. The vehicle 100 travels in the second traveling state in a case where the SOC is lower than the charge start SOC or in a case where the vehicle 100 requires a large driving force. In addition, in a case where the vehicle 100 does not require a large driving force or the battery SOC is charged to the SOC set to the normal charge target SOC in a state where the battery SOC of the vehicle 100 is charged from the charge start SOC, the state transitions to the first traveling state, and the vehicle travels while switching between the second traveling state and the first traveling state.

In the fourth embodiment of the present invention, in a case where travel track records are accumulated in the travel track record accumulation unit 29A, a charge target value correction section is set in a region further outside the virtual circle 32. In the charge target value correction section, a temporary node is set at an intersection of a link having a travel track record and the virtual circle 32, a route search is performed similarly to the route generation unit 24 of the vehicle control device 21 according to the first embodiment of the present invention, and a link outside the virtual circle 32 and having a travel track record is extracted.

For example, a distance traveled for 3 minutes or 5 minutes or the like can be set by an average velocity of a link having a point or an intersection having a predetermined amount in which a distance from an intersection with the virtual circle 32 as a starting point is the same as a radius of the virtual circle 32. To such a point, the charge target SOC in the second traveling state is corrected to be closer to the charge side.

The correction amount of the charge target value is set by a method of adding a predetermined amount such as +5% or +10% to the SOC as the first traveling state execution determination value or the normal charge target SOC in the node outside the virtual circle 32 over the charge target value correction section, and is set to a value such as +5% or +10% to the SOC as the first traveling state execution determination value or the normal charge target SOC in the node outside the virtual circle 32 at the intersection of the virtual circle 32 described above. On the other hand, at the end of the charge target correction section, the SOC may change based on the positional relationship with the intersection with the virtual circle 32 so as to set the normal charge target SOC. The battery SOC of the vehicle 100 is preferably set to be high at the intersection with the virtual circle 32.

In addition, these correction amounts may be set to different values for the charge target value correction sections corresponding to the respective intersections. For example, it is determined whether the link has a large amount of travel track records or a small amount of travel track records by comparing the number of points of the travel track records with respect to the unit distance of the link having an intersection with the virtual circle 32.

Then, a target value on the charge side, such as the SOC as the first traveling state execution determination value or +10% in the node outside the virtual circle 32, is set so as to be further the charge side in the link having a large amount of travel track records. On the other hand, in the link having a small amount of travel track records, the correction amount may be changed according to the travel track records by setting the discharge side as compared with the link having a large amount of travel track records.

For a link (route) with a small amount of travel track records, it is considered that the possibility of traveling to the base is not necessarily high as in the case where the travel track record is obtained, and thus, there is a possibility that the fuel consumption deteriorates due to the charging operation.

In FIG. 20, regarding the fourth embodiment of the present invention in which the charge target value correction section is provided according to the travel track record, changes in the battery SOC are illustrated using the first to third embodiments in which the charge target value correction section is not provided as comparative examples. Both the fourth embodiment and comparative examples start from the same SOC at the left end of the chart. In the comparative examples, the state is changed from the second traveling state to the first traveling state at the point xA where the normal charge target SOC is reached, but thereafter, the state is changed again to the second traveling state at the point exceeding xC, and the state is finally changed to the final first traveling state at the point xB so that the vehicle reaches the house.

On the other hand, in the fourth embodiment, since the charge target value correction section is provided, the second traveling state is continued even after passing through the point xA, and the SOC which is the first traveling state execution determination value is exceeded at the point xC, so that the vehicle can travel to the house in the first traveling state thereafter.

In addition, in the fourth embodiment, by providing the charge target value correction section at a point outside the virtual circle 32, it is possible to enter the virtual circle 32 where the first traveling state execution determination value exists in a state where the SOC is increased, and thus, it is possible to increase the distance that the vehicle can travel in the first traveling state, and thus, it is possible to increase the opportunity to provide the traveling state with high quietness based on the first traveling state.

That is, the target charge state setting unit 29B corrects the target charge state of the battery 105 based on the travel track records of the vehicle 100 accumulated in the travel track record accumulation unit 29A, drives the engine 102 to drive the generator or directly drives the drive wheel at a point not stored in the determination value storage unit 27 to set the second traveling state in which the vehicle 100 travels while driving the engine 102, and corrects the target charge state of the battery 105 in the second traveling state to the high charge side.

As described above, according to the fourth embodiment of the present invention, the same effects as those of the first embodiment can be obtained, and the opportunity to provide the traveling state with high quietness in the first traveling state can be increased.

### Fifth Embodiment

Next, a fifth embodiment of the present invention will be described.

In the fifth embodiment of the present invention, among the functions included in the vehicle control device 21 illustrated in FIG. 2 in the first embodiment of the present invention, calculation resources outside the vehicle 100 different from the calculation resource 70 in the vehicle 100 are used for the functions of the route generation unit 24, the energy consumption amount calculation unit 25, and the battery charge amount planning unit 26.

For example, the first traveling state start determination value information for the base determined by the base setting unit 23 is requested to a server (having a calculation resource) installed in a data center or the like via the telematics device 10 which is a communication device of the vehicle 100, and the calculation result is received and acquired again via the telematics device 10 and stored in the determination value storage unit 27.

In this way, the functions of the route generation unit 24, the energy consumption amount calculation unit 25, and the battery charge amount planning unit 26 that require calculation resources can be executed on a server rich in calculation resources, and it is possible to increase the number of bases, form the vehicle control device 21 at low cost, and calculate an energy consumption amount in consideration of a dynamic map, for example, regulation due to construction, occurrence of an accident, and the like as map information.

For example, the travel time and the average velocity change due to traffic congestion caused by restriction due to construction or occurrence of an accident. By reflecting such changed travel time and average velocity, the calculation accuracy of the energy consumption amount is improved. In addition, in the first embodiment of the present invention, the average power consumption for estimating the energy consumption amount based on the travel track records of the own vehicle is calculated, but the travel track records other than the own vehicle may be also aggregated in the server, so that the energy consumption amount can be estimated in consideration of the energy consumption amount of the vehicle other than the own vehicle in the link to be calculated.

As a result, according to the fifth embodiment of the present invention, the same effects as those of the first embodiment can be obtained, and the functions of the route generation unit 24, the energy consumption amount calculation unit 25, and the battery charge amount planning unit 26 can be configured on a calculation resource other than the calculation resource included in the vehicle 100, particularly, a server capable of performing communication via the telematics device 10 of the vehicle 100.

As a result, abundant calculation resources can be utilized, and the estimation accuracy of the energy consumption amount can be enhanced. Therefore, since the timing to start the first traveling state can be correctly estimated, the opportunity to cause the vehicle 100 to travel in the first traveling state toward the point as the base can be expanded.

The calculation resource 70 illustrated in FIG. 2 can be replaced with a server (installed outside the vehicle 100) capable of communication via the telematics device 10, and determination information for determining whether or not the vehicle 100 travels in the first traveling state is received from the server via the telematics device 10 and stored in the determination value storage unit 28.

A vehicle control method in the fifth embodiment will be described.

A vehicle control method in the fifth embodiment is a vehicle control method of the vehicle 100 in which the first traveling state in which the vehicle 100 is driven by transmitting a driving force of an electric motor 107 by power supply from the battery 105 to the drive wheels 109 and the second traveling state in which the vehicle 100 is driven with at least operation of the engine 102 can be switched. The method acquires map information, and sets a predetermined point of the map information as a base.

Next, a set route from a peripheral point of the base to the base, an energy consumption amount when the vehicle 100 travels on the route toward the base, and a battery charge amount plan for planning the charge amount of the battery 105 so that the vehicle 100 travels on the route from the predetermined point on the route in the first traveling state and reaches the base with the battery 105 of the vehicle 100 which is a predetermined charge amount based on the energy consumption amount are acquired from the calculation resource 70 provided outside the vehicle 100 via the communication device 10. Then, a determination value obtained from the battery consumption amount required for the vehicle 100 to travel in the first traveling state from the predetermined point to the bases 31, 31A, and 31B and the target battery remaining amount at the time of arrival at the bases 31, 31A, and 31B is allocated and stored for each of the plurality of predetermined points, whether or not the vehicle 100 travels in the first traveling state is determined in association with the battery charge amount according to the battery charge amount plan and the point on the route in the map information, and traveling in the first traveling state is started when the current battery charge amount of the vehicle 100 exceeds the determination value corresponding to the current point of the vehicle 100.

According to the fifth embodiment of the present invention, in addition to the effects similar to those of the first embodiment, it is possible to provide the vehicle control device 21 and the vehicle control method which can execute the functions of the route generation unit 24, the energy consumption amount calculation unit 25, and the battery charge amount planning unit 26 on the server rich in calculation resources, can increase the number of bases, can form the vehicle control device 21 with low cost, and can calculate energy consumption amount in consideration of a dynamic map as map information, for example, regulation due to construction, occurrence of an accident, and the like.

The preferred embodiments of the present invention have been described above. In the embodiments of the present invention and the drawings used for the description thereof, only configurations necessary for the description of the invention are described. In a case where the invention is actually implemented, configurations and functions that are not described in an embodiment of the present invention are naturally achieved using a known technique.

Therefore, the present invention is not necessarily characterized by including all the configurations described above, and is not limited to the configurations of the embodiments described above. It is possible to replace a part of the configuration of the embodiment of the present invention with another embodiment, and it is possible to add, delete, and replace other configurations with respect to a part of the configuration of each embodiment unless the characteristics thereof are significantly changed.

Note that the present invention is not limited to the above-described embodiments, and includes various modifications. For example, the above-described embodiments have been described in detail in order to simply describe the present invention, and are not necessarily limited to those having all the described configurations.

According to the present invention, it is possible to automatically start electric traveling with high quietness even when a driver does not perform a switching operation when a hybrid vehicle travels near a set base or the like.

In addition, even if the driver does not register the base information, it is possible to automatically start the electric traveling with high quietness even if the driver does not perform the switching operation to the point which is frequently visited and can be the base.

In addition, it is possible to perform the electric traveling with high quietness for both the travel toward the base and the travel departing from the base and to eliminate the imbalance of the distance in which the vehicle can travel in the first traveling state.

In addition, in a case where the driver approaches the base or the like via the route usually used by the driver, the region where the vehicle can travel in the first traveling state can be enlarged.

In addition, even when there are a plurality of points that can be bases and these points are close to each other, it is possible to increase opportunities for traveling in the first traveling state.

In addition, even when continuation of the first traveling state becomes difficult, when the vehicle continues traveling toward the base, it is possible to cause the vehicle to travel so as to suppress an increase in noise as much as possible.

In addition, it is possible to increase opportunities for traveling in the first traveling state by training the cases where it is necessary to increase the battery charge amount in order to travel in the first traveling state and reflecting it in subsequent traveling.

In addition, it is possible to increase opportunities for traveling to a larger number of bases in the first traveling state.

In addition, it is possible to notify the driver of the automatic switching to the first traveling state and to provide information for the driver to easily continue the first traveling state.

In addition, it is possible to appropriately stop the control for automatically switching to the first traveling state in response to the request of the driver.

### REFERENCE SIGNS LIST

1 integrated controller
2 communication bus
3 engine controller
4 generator controller
5 battery controller
6 drive motor controller
7 brake controller
8 map unit
9 interface device
10 telematics device
21 vehicle control device
22 map information acquisition unit
23 base setting unit
23A base estimation unit
23B base information storage unit
24 route generation unit
25 energy consumption amount calculation unit
26 battery charge amount planning unit
27 determination value storage unit
28 traveling state determination unit
29A travel track record accumulation unit
29B target charge state setting unit
31 house (base)
31A, 31B base
32 virtual circle
33 intersection
34 base node
35 region in which virtual circles overlap
36 own vehicle position
37A, 37B route
8, 40, 41 node
39A, 39B SOC plan
50 map image
51 own vehicle position icon
52 icon
53 text
54 button
55 travel track record
61, 65 node link attribution information reference unit
62 average power consumption calculation unit
63 average power consumption database
64 inter-link energy consumption amount estimation unit
65 node link attribution information reference unit
66 own vehicle information reference unit
67 velocity pattern generation unit
68 energy consumption amount estimation unit
68A kinetic energy estimation unit
68B electric energy estimation unit
69 velocity sensor
70 calculation resource
100 vehicle
101 fuel tank
102 engine
103 generator
104 generator inverter
105 battery
106 drive inverter
107 drive motor (electric motor)
108 deceleration/differential device
109 drive wheel
110 steering device
111 brake actuators
112 positioning sensor

1. A vehicle control device mounted on a vehicle capable of switching between a first traveling state in which the vehicle is driven by transmitting a driving force of an electric motor by power supply from a battery to drive wheels and a second traveling state in which the vehicle is driven with at least operation of an engine, the vehicle control device comprising:
a determination value storage unit which allocates and stores a determination value obtained based on a battery consumption amount required for the vehicle to travel from a predetermined point to a base in the first traveling state and a target battery remaining amount at the time when the vehicle reaches the base for each of a plurality of predetermined points; and
a traveling state determination unit which starts traveling in the first traveling state in a case where a current battery charge amount of the vehicle exceeds the determination value corresponding to a current point of the vehicle.

2. The vehicle control device according to claim 1, comprising:
a map information acquisition unit which acquires map information;
a base setting unit which sets a predetermined point of the map information as a base;
a route generation unit which generates a route from a peripheral point of the base set by the base setting unit to the base;
an energy consumption amount calculation unit which calculates an energy consumption amount in a case where the vehicle travels on the route toward the base; and
a battery charge amount planning unit which plans the battery charge amount based on the energy consumption amount such that the vehicle travels on the route from a predetermined point of the route in the first traveling state, and reaches the base with a predetermined charge amount of a battery of the vehicle, wherein
the determination value is determination information for determining whether or not the vehicle travels in the first traveling state by associating the battery charge amount planned by the battery charge amount planning unit with a point of the route in the map information.

3. The vehicle control device according to claim 2, wherein
the base setting unit further comprises:
a base estimation unit which estimates a point to be the base; and
a base information storage unit which stores information for estimating the base, wherein
the base estimation unit stores information for estimating the base in the base information storage unit so as to refer to a point where the vehicle has ended the driving by tracing back to the driving of the vehicle a predetermined number of times before, and estimates a point having a high appearance frequency as a point where the vehicle has ended the driving as the base.

4. The vehicle control device according to claim 2, wherein
the base setting unit further comprises
a base estimation unit which estimates a point to be the base; and
a base information storage unit which stores information for estimating the base,
the base estimation unit
stores in a base information storage unit a point at which driving of the vehicle is ended and a point at which driving is started, and a time at which the driving is ended and a time at which the driving is started which are associated respectively,
estimates a time at which the driving is ended or started as a base where switching to the first traveling state is to be performed based on a fact that the time at which the driving is ended or started falls within in a predetermined time zone, and determines whether or not to store information in the base information storage unit based on an elapsed time from the end of the driving to the start of the driving.

5. The vehicle control device according to claim 2, wherein
the route generation unit further generates a route from the base toward a periphery of the base, and
the battery charge amount planning unit
corrects a charge amount when the vehicle reaches the base based on a difference between an energy consumption amount of a route from the periphery of the base to the base and an energy consumption amount of a route from the base to the periphery of the base.

6. The vehicle control device according to claim 2, further comprising:
a travel track record accumulation unit which accumulates a travel track record of a vehicle in association with the map information;
a target charge state setting unit which corrects a target charge state, wherein
the target charge state setting unit corrects the target charge state of the battery based on the travel track record of the vehicle accumulated in the travel track record accumulation unit, sets a second traveling state in which the vehicle travels while driving the engine and driving a generator, or directly driving drive wheels and driving the engine at a point not stored in the determination value storage unit, and corrects the target charge state of the battery in the second traveling state to a high charge side.

7. The vehicle control device according to claim 2, wherein
the determination value storage unit stores a first traveling state execution determination value indicating a charge state of the battery required to reach the base, and
the traveling state determination unit compares the first traveling state execution determination value for the vehicle to reach a first base with the first traveling state execution determination value having a value different from the first traveling state execution determination value for the vehicle to reach a second base, and determines a traveling state based on the first traveling state execution determination value on a higher charge side.

8. The vehicle control device according to claim 2, wherein
in response to a state where the first traveling state cannot be continued, an engine is operated at a low output, and a transition is made to a third traveling state in which an output of the engine is reduced and noise is reduced while only a generator is driven.

9. The vehicle control device according to claim 2, wherein
in response to a state where the vehicle cannot continue the first traveling state, the traveling state determination unit stores in the determination value storage unit a point at which the first traveling state is ended, and corrects an execution determination value of a section in which an execution determination value falls in a previous travel route to a charge side.

10. The vehicle control device according to claim 2, further comprising
an interface device which notifies a driver that the vehicle is in the first traveling state, wherein the interface device notifies information regarding the base and an execution determination value in the first traveling state when the vehicle starts the first traveling state.

11. A vehicle control method of a vehicle capable of switching between a first traveling state in which the vehicle is driven by transmitting a driving force of an electric motor by power supply from a battery to drive wheels and a second traveling state in which the vehicle is driven with at least operation of an engine, the vehicle control method comprising:
acquiring map information;
setting a predetermined point of the map information as a base;
acquiring, via a communication device from a calculation resource installed outside the vehicle, a route from a peripheral point of the set base to the base, an energy consumption amount in a case where the vehicle travels on the route toward the base, and a battery charge amount plan which plans the battery charge amount based on the energy consumption amount such that the vehicle travels on the route from a predetermined point of the route in the first traveling state, and reaches the base with a predetermined charge amount of a battery of the vehicle;
allocating and storing, a determination value obtained based on a battery consumption amount required for the vehicle to travel from a predetermined point to a base in the first traveling state and a target battery remaining amount at the time when the vehicle reaches the base for each of a plurality of predetermined points;
determining whether or not the vehicle travels in the first traveling state by associating the charge amount of the battery according to the battery charge amount plan with a point of the route in the map information; and
starting traveling in the first traveling state in a case where a current battery charge amount of the vehicle exceeds the determination value corresponding to a current point of the vehicle.
